(19) United States
(12) Patent Application Publication
(10) Pub. No.: US 2026/0331095 A1
(43) Pub. Date: Oct. 22, 2026

(54) METHOD FOR TRAINING AUDIO RECOGNITION MODEL, ELECTRONIC DEVICE, AND PROGRAM PRODUCT

(71) Applicant: MASHANG CONSUMER FINANCE CO., LTD., Chongqing (CN)

(72) Inventor: Qinglin MENG, Chongqing (CN)

(21) Appl. No.: 19/343,677

(22) Filed: Sep. 29, 2025

(30) Foreign Application Priority Data
Apr. 16, 2025 (CN) 202510489434.0

(51) Int. Cl. G10L 15/06; G06N 3/0455; G06N 3/09; G10L 15/16

(52) U.S. Cl. CPC G10L 15/063; G06N 3/0455; G06N 3/09; G10L 15/16

(57) ABSTRACT

A method for training a model, an electronic device and a storage medium are provided. The method for training a mode includes: encoding an audio data sample using an encoder in the model, to obtain first feature vectors; performing attention mapping on the first feature vectors based on at least one preset phrase using a biasing encoder in the model, to obtain second feature vectors; decoding the second feature vectors using a decoder in the model, to obtain first probabilities; performing attention mapping on the first probabilities based on the at least one preset phrase using a biasing decoder in the model, to obtain second probabilities; determining a loss value based on text labels for the audio data sample, the first feature vectors, the first probabilities, and the second probabilities; tuning parameters of the model based on the loss value, to obtain a trained model.

### CROSS-REFERENCE TO RELATED APPLICATION

This application claims the benefit of priority of Chinese Patent Application No. 202510489434.0, filed on Apr. 16, 2025, the contents of which are incorporated herein by reference in its entirety for all purposes.

### RELATED ART

At present, significant progress has been made in end-to-end audio recognition systems based on neural networks. These systems directly convert audio signals into texts through deep learning models, thus reducing the complexity of multiple operations in traditional audio recognition systems. However, although overall performance has improved, audio recognition accuracy is low when processing rare words or specific contextual terms (such as proper nouns) not included in the training dataset.

### SUMMARY

Embodiments of the present disclosure relates to the field of natural language processing technologies, and provide a method for training an audio recognition model, an electronic device, and a storage medium.

In a first aspect, an embodiment of the present disclosure provides a method for training a model, which includes: encoding an audio data sample using an encoder in the model, to obtain first feature vectors; performing attention mapping on the first feature vectors based on at least one preset phrase using a biasing encoder in the model, to obtain second feature vectors; decoding the second feature vectors using a decoder in the model, to obtain first probabilities; performing attention mapping on the first probabilities based on the at least one preset phrase using a biasing decoder in the model, to obtain second probabilities; determining a loss value based on text labels for the audio data sample, the first feature vectors, the first probabilities, and the second probabilities; and tuning parameters of the model based on the loss value, to obtain a trained model.

In a second aspect, an embodiment of the present disclosure provides an electronic device, including: a memory for storing computer-executable instructions or a computer program; and a processor, configured to execute the computer-executable instructions or the computer program stored in the memory to implement operations of: encoding an audio data sample using an encoder in a model, to obtain first feature vectors; performing attention mapping on the first feature vectors based on at least one preset phrase using a biasing encoder in the model, to obtain second feature vectors; decoding the second feature vectors using a decoder in the model, to obtain first probabilities; performing attention mapping on the first probabilities based on the at least one preset phrase using a biasing decoder in the model, to obtain second probabilities; determining a loss value based on text labels for the audio data sample, the first feature vectors, the first probabilities, and the second probabilities; and tuning parameters of the model based on the loss value, to obtain a trained model.

In a third aspect, an embodiment of the present disclosure provides a non-transitory computer-readable storage medium having stored thereon a computer program or computer-executable instructions that, when executed by a processor, implements or implement a method for training a model including: encoding an audio data sample using an encoder in the model, to obtain first feature vectors; performing attention mapping on the first feature vectors based on at least one preset phrase using a biasing encoder in the model, to obtain second feature vectors; decoding the second feature vectors using a decoder in the model, to obtain first probabilities; performing attention mapping on the first probabilities based on the at least one preset phrase using a biasing decoder in the model, to obtain second probabilities; determining a loss value based on text labels for the audio data sample, the first feature vectors, the first probabilities, and the second probabilities; and tuning parameters of the model based on the loss value, to obtain a trained model.

### BRIEF DESCRIPTION OF THE DRAWINGS

FIG. 1 is a structural diagram illustrating the architecture of an audio recognition system according to an embodiment of the present disclosure.

FIG. 2 is a structural diagram of an electronic device according to an embodiment of the present disclosure.

FIG. 3A is a first flowchart of a method for training an audio recognition model according to an embodiment of the present disclosure.

FIG. 3B is a second flowchart of a method for training an audio recognition model according to an embodiment of the present disclosure.

FIG. 3C is a third flowchart of a method for training an audio recognition model according to an embodiment of the present disclosure.

FIG. 3D is a fourth flowchart of a method for training an audio recognition model according to an embodiment of the present disclosure.

FIG. 3E is a fifth flowchart of a method for training an audio recognition model according to an embodiment of the present disclosure.

FIG. 3F is a sixth flowchart of a method for training an audio recognition model according to an embodiment of the present disclosure.

FIG. 3G is a seventh flowchart of a method for training an audio recognition model according to an embodiment of the present disclosure.

FIG. 3H is an eighth flowchart of a method for training an audio recognition model according to an embodiment of the present disclosure.

FIG. 4 is a diagram of a principle for training the audio recognition model according to an embodiment of the present disclosure.

FIG. 5 is a diagram of a principle for calculating a first sub-loss value according to an embodiment of the present disclosure.

FIG. 6 is a structural diagram of a biasing network according to an embodiment of the present disclosure.

FIG. 7 is a structural diagram of a phrase prediction network according to an embodiment of the present disclosure.

It is to be noted that “first” and “second” above are only used to distinguish different solutions, and do not represent a degree of superiority or inferiority of the solutions, or a priority in the implementation procedure.

### DETAILED DESCRIPTION

To make the objectives, technical solutions, and advantages of the present disclosure clearer, the present disclosure will be described in further detail below with reference to the drawings. The described embodiments should not be regarded as limiting the present disclosure. All other embodiments that are obtained by those of ordinary skill in the art without involving inventive skill fall within the scope of protection of the present disclosure.

When the following description refers to “some embodiments”, the phrasing describes a subset of all possible embodiments, but it can be understood that “some embodiments” may be the same subset or different subsets of all possible embodiments, and may be combined with each other without conflict.

The term “first\second third” as referred to in the following description is only to distinguish similar objects, and does not represent a specific ordering of objects. It can be understood that the specific order or sequential order of “first\second\third” may be interchanged if allowed, so that the embodiments of the present disclosure described herein can be implemented in an order other than those illustrated or described herein.

In the embodiments of the present disclosure, the term “module” or “unit” refers to a computer program or a part of a computer program that has a predetermined function, works together with other related parts to achieve a predetermined objective, and may be implemented in whole or in part by using software, hardware (such as a processing circuit or a memory), or a combination thereof. Similarly, one processor (or multiple processors or memories) may be used to implement one or more modules or units. Furthermore, each module or unit may be a part of an integral module or unit that includes the functionality of the module or unit.

Unless otherwise defined, all technical and scientific terms used in the embodiments of the present disclosure have the same meanings as commonly understood by a person of ordinary skill in the technical field to which the present disclosure belongs. The terms used in the embodiments of the present disclosure are only for the purpose of describing the embodiments of the present disclosure, and are not intended to limit the present disclosure.

In the embodiments of the present disclosure, the relevant data collection processing, when applied to examples, should strictly obtain informed consent or separate consent for the personal information subject according to the requirements of relevant laws and regulations, and carry out subsequent data use and processing within the scope of the laws and regulations and the authorization of the personal information subject.

Before the embodiments of the present disclosure are further described in detail, the nouns and terms referred to in the embodiments of the present disclosure are illustrated. The nouns and terms referred to in the embodiments of the present disclosure are applicable to the following explanations.
1) Audio recognition (or speech recognition) is a technology that converts human speech into text. The goal of the audio recognition is to enable that computers “understand” human language and accurately convert speech information into a text output.
2) A Long Short-Term Memory (LSTM) is a variant of a Recurrent Neural Network (RNN), solving problems of gradient disappearance and gradient explosion in a traditional RNN by introducing a gating mechanism, so that the model can better capture long-term dependencies in sequences.
3) A transformer refers to a sequential model based on a Self-Attention mechanism. The transformer can effectively encode sequential information at the encoder part, demonstrating significantly superior performance in processing the sequential information compared to the LSTM, while offering faster processing speed. The transformer is widely used in the fields such as natural language processing, computer vision, machine translation, speech recognition.
4) Connectionist Temporal Classification (CTC) is a commonly used loss function in audio recognition tasks. The basic principle of the CTC loss function is to map continuous audio signals into a sequence of continuous text characters without requiring prior knowledge of word boundaries in the audio. In this way, the task of the model is simplified to directly predicting the text without the need for additional word segmentation operations.
5) Preset phrases refer to phrases preset for specific fields or specific application scenarios, such as proper nouns, high-frequency terms, hot terms, and business terms (such as product names) in the financial field.
6) A phrase prediction network (Contextual Phrase Prediction Network, CPP Network) is a neural network that predicts related phrases based on contextual information.
7) A Convolution-augmented Transformer (Conformer) refers to a model architecture that combines the Transformer and the Convolutional Neural Network (CNN). The Transformer model is good at capturing content-based global interactions, while the CNN effectively uses local features, allowing the Conformer model to better model long-term global interaction information and local features.
8) A context-enhanced efficient automatic speech recognition framework (SEQ-former) is an end-to-end speech recognition framework that combines advantages of the CTC, an Attention-based Encoder-Decoder (AED) and a Recurrent Neural Network Transducer (RNN-T).

In related technologies, significant progress has been made in end-to-end audio recognition systems based on neural networks. These systems directly convert audio signals into text through deep learning models, thus reducing the complexity of multiple operations in traditional audio recognition systems. However, although overall performance has improved, audio recognition accuracy is low when processing rare terms or specific contextual terms (such as proper nouns) not included in the training dataset. Embodiments of the present disclosure provide a method and an apparatus for training an audio recognition model, a device, a computer readable storage medium, and a computer program product, which can improve audio recognition accuracy.

Hereinafter, an exemplary application of the electronic device provided by the embodiments of the present disclosure will be described. The electronic device provided in the embodiments of the present disclosure may be implemented as various types of terminal devices, such as a notebook computer, a tablet computer, a desktop computer, a set-top box, a smart phone, a smart speaker, a smart watch, a smart television, or an in-vehicle terminal, or may be implemented as a server.

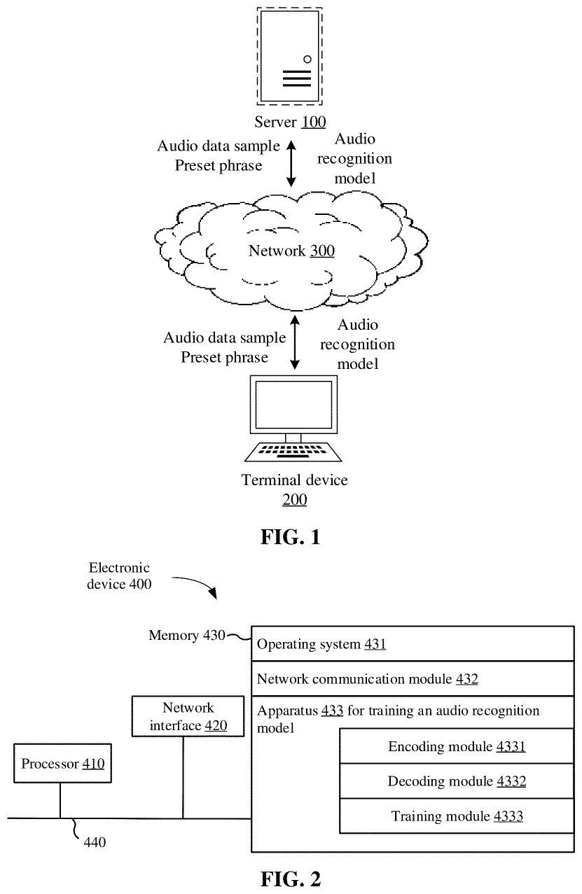

With reference to FIG. 1, FIG. 1 is a structural diagram of architecture of an audio recognition system provided in an embodiment of the present disclosure. FIG. 1 relates to a server 100, a terminal device 200, and a network 300. The terminal device 200 is connected to the server 100 through the network 300. The network 300 may be a wide area network or a local area network, or a combination of both.

In some embodiments, the embodiments of the present disclosure may be implemented by the server and the terminal device in collaboration. For example, the terminal device 200 transmits audio data samples and preset phrases to the server 100. The server 100 receives the audio data samples and the preset phrases, obtains a trained audio recognition model by the method for training the audio recognition model (also called as the method for training a model) provided in the embodiments of the present disclosure, and transmits the trained audio recognition model to the terminal device 200.

In other embodiments, the embodiments of the present disclosure may be implemented separately by the terminal device. The terminal device 200 obtains local audio data samples and preset phrases, and obtains a trained audio recognition model by the method for training the audio recognition model provided in the embodiments of the present disclosure.

In some embodiments, the terminal device or the server may implement the method for training the audio recognition model provided in the embodiments of the present disclosure by running various computer executable instructions or computer programs. For example, the computer executable instructions may be microprogram-level commands, machine instructions, or software instructions. The computer program may be a native program or a software module in the operating system. In summary, the above-described computer executable instructions may be any form of instructions, the above-described computer programs may be any form of application programs, modules, or plug-ins, and the terminal device includes, but is not limited to, a mobile phone, a computer, a smart voice interactive device, a smart home appliances, an in-vehicle terminal, or the like.

With reference to FIG. 2, FIG. 2 is a structural diagram of an electronic device according to an embodiment of the present disclosure. The electronic device 400 illustrated in FIG. 2 includes: at least one processor 410, a memory 430, and at least one network interface 420. Various components in the electronic device 400 are coupled together by means of a bus system 440. It may be understood that the bus system 440 is used to implement connection and communication between these components. The bus system 440, in addition to a data bus, includes a power supply bus, a control bus, and a status signal bus. However, for the sake of clear illustration, the various buses are all designated as the bus system 440 in FIG. 2.

The processor 410 may be an integrated circuit chip having signal processing capabilities, such as a general-purpose processor, a Digital Signal Processor (DSP), or another programmable logic device, a discrete gate or transistor logic device, a discrete hardware component, or the like. The general-purpose processor may be a microprocessor, any conventional processor, or the like.

The memory 430 may be removable, non-removable, or a combination thereof. An exemplary hardware device includes a solid-state memory, a hard disk drive, an optical-disc drive, or the like. The memory 430 optionally includes one or more memory devices physically located remote from the processor 410.

The memory 430 includes a volatile memory or a nonvolatile memory, or may include both a volatile memory and a nonvolatile memory. The non-volatile memory may be a Read-Only Memory (ROM), and the volatile memory may be a Random Access Memory (RAM). The memory 450 described in the embodiments of the present disclosure is intended to include any suitable type of memory.

In some embodiments, the memory 430 can store data to support various operations. Examples of the data include programs, modules and data structures, or a subset or superset thereof, as exemplarily described below.

An operating system 431 includes a system program used to process various basic system services and execute hardware-related tasks, such as a framework layer, a core library layer, and a driver layer, and used to implement various basic services and process hardware-based tasks.

A network communication module 432 is used to access another electronic device via one or more (wired or wireless) network interfaces 420. An exemplary network interface 420 includes: Bluetooth, Wireless Fidelity (Wi-Fi), a Universal Serial Bus (USB), and the like.

In some embodiments, an apparatus according to an embodiment of the present disclosure may be implemented using software means, and FIG. 2 illustrates an apparatus 433 for training an audio recognition model stored in the memory 430, which may be software in a form of a process, a plug-in and/or the like, including the following software modules: an encoding module 4331, a decoding module 4332, and a training module 4333, these modules being logical modules, and thus capable of being arbitrarily combined or further split according to the functions implemented. Functions of the modules are described hereinafter.

In some other embodiments, the apparatus according to an embodiment of the present disclosure may be implemented using hardware means. As an example, the apparatus according to an embodiment of the present disclosure may be a processor in the form of a hardware decoding processor which is programmed to perform a method for training an audio recognition model according to an embodiment of the present disclosure. For example, the processor in the form of the hardware decoding processor may use one or more Application Specific Integrated Circuits (ASIC), Digital Signal Processors (DSP), Programmable Logic Devices (PLD), Complex Programmable Logic Devices (CPLD), Field-Programmable Gate Arrays (FPGA) or other electronic elements.

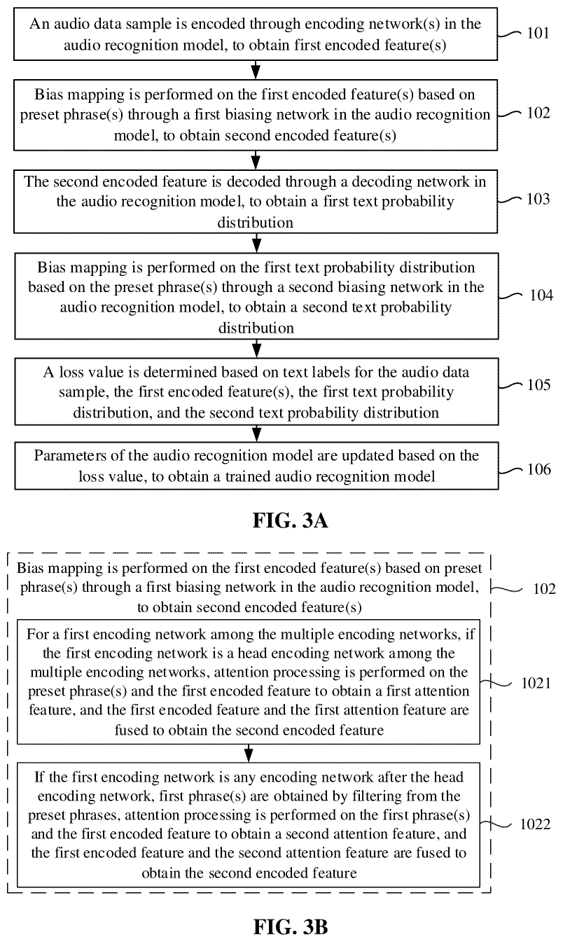

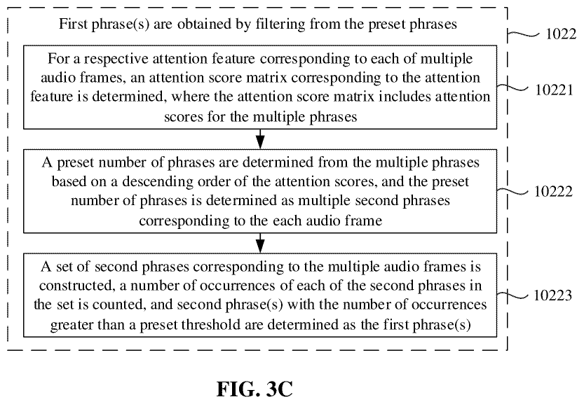

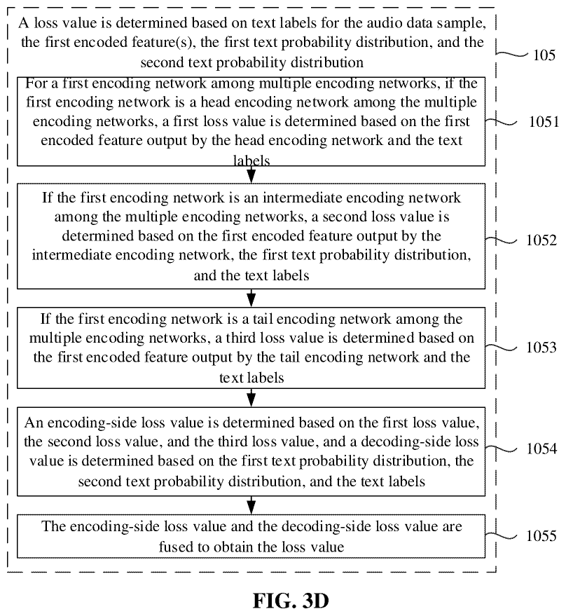

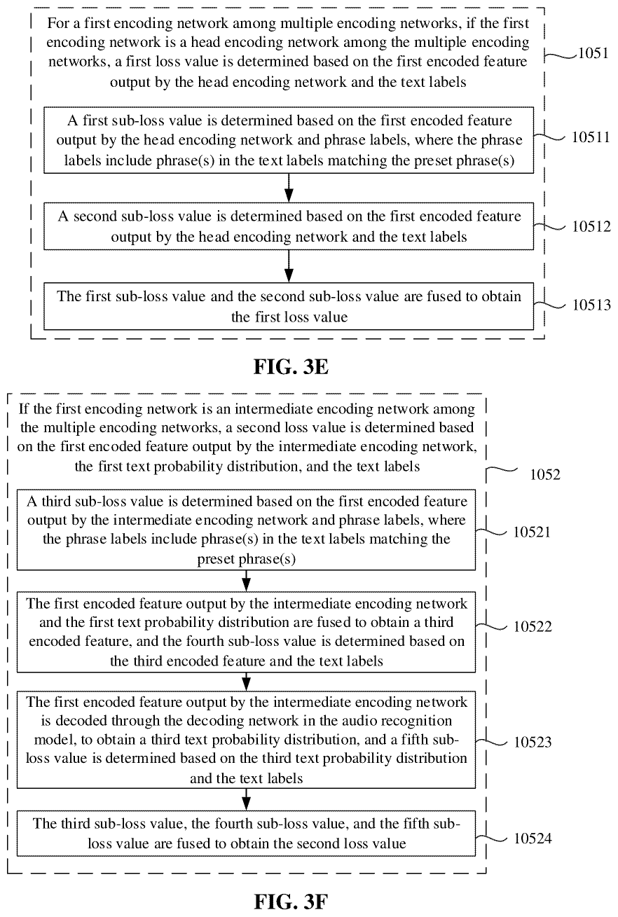

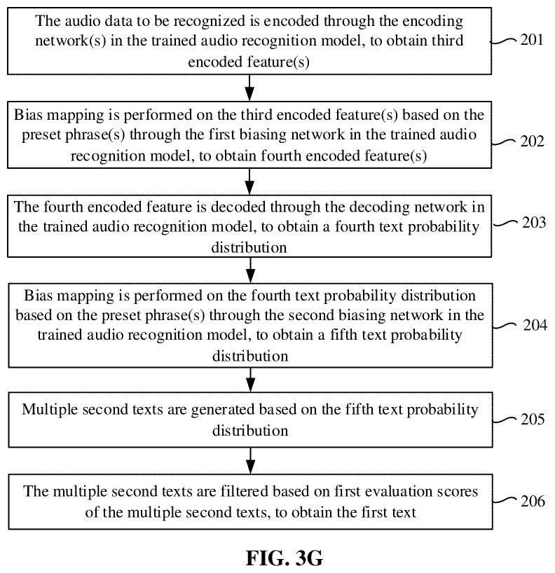

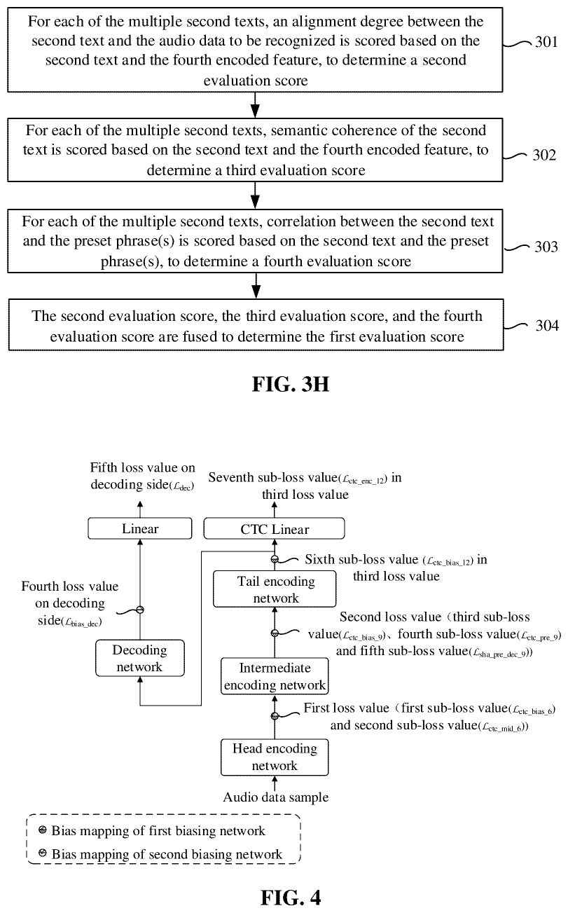

Hereinafter, the method for training the audio recognition model provided by the embodiments of the present disclosure will be described with reference to an exemplary application and implementation of the server provided by the embodiments of the present disclosure, in which the performing entity is the server. With reference to FIG. 3A, FIG. 3A is a first schematic flowchart of a method for training an audio recognition model according to an embodiment of the present disclosure, and the method is described with reference to the operations illustrated in FIG. 3A.

At the operation 101, an audio data sample is encoded through encoding network(s) in the audio recognition model, to obtain first encoded feature(s).

Here, the encoding network(s) are included in an encoder. In other words, the audio data sample is encoded through the encoder to obtain the first encoded feature corresponding to the audio data sample.

Here, the audio data sample includes multiple audio frames. Each audio frame corresponds to a respective first encoded feature represented by a first feature vector. In other words, the first encoded feature corresponding to the audio data sample includes first feature vectors corresponding to the multiple audio frames.

Here, the audio recognition model is an artificial intelligence model for processing and analyzing audio signals, and is capable of converting audio data into text data. The audio recognition model may be used in various scenarios (such as telephone customer service call transcription, real-time meeting subtitle generation, voice assistant, smart speaker) that require the audio recognition.

In some embodiments, the operation 101 is implemented by performing the following processing through the encoding network(s) in the audio recognition model: performing framing processing on the audio data sample to obtain audio frames; performing frequency domain transformation processing on the audio frames to obtain a frequency domain representation for the audio frames; performing acoustic feature extraction processing on the frequency domain representation to obtain spectrum features; and performing feature encoding processing on the spectrum features to obtain the first encoded feature(s).

For example, the audio data sample may be preprocessed before encoding, such as removing noises, adjusting sampling rates and gains, to ensure audio quality. Framing processing is performed on the preprocessed audio data sample to obtain audio frames with a fixed length, and Hamming window or Hanning window processing is performed on each audio frame, to reduce the spectrum leakage. Frequency domain transformation processing is realized by performing Fast Fourier Transform (FFT) on each audio frame, to obtain a frequency domain representation. Mel-Frequency Cepstral Coefficients (MFCC) or other acoustic features are calculated on the basis of the frequency domain representation, for acoustic feature extraction to represent the spectral features of the audio data sample. Feature encoding processing is performed on the spectral features through the encoding network, to obtain the first encoded feature. For example, the encoding network may be constructed based on a Conformer Encoder, where the Conformer Encoder includes components such as an convolutional layer, a self-attention layer, and a feed-forward network layer, and is used to process and transform the spectral features into the first encoded feature. The embodiments of the present disclosure do not limit the specific number of layers and the specific network architecture of the encoding network.

At the operation 102, bias mapping is performed on the first encoded feature(s) based on the preset phrase(s) through a first biasing network in the audio recognition model, to obtain second encoded feature(s).

In some embodiments, the number of the encoding networks is multiple, and the multiple encoding networks may include a head encoding network, an intermediate encoding network, and a tail encoding network. The head encoding network refers to an encoding network located in a first layer number interval in the audio recognition model. The intermediate encoding network refers to an encoding network located in a second layer number interval in the audio recognition model. The tail encoding network is an encoding network located in a third layer number interval in the audio recognition model. The maximum layer number in the first layer number interval is smaller than the minimum layer number in the second layer number interval, and the maximum layer number in the first layer number interval and the minimum layer number in the second layer number interval are consecutive positive integers. The maximum layer number in the second layer number interval is smaller than the minimum layer number in the third layer number interval, and the maximum layer number in the second layer number interval and the minimum layer number in the third layer number interval are consecutive positive integers.

Here, the layer number refers to the sequential number of the encoding network in the audio recognition model in a direction from the input to the output.

For example, with reference to FIG. 4, FIG. 4 is a schematic diagram of a principle for training the audio recognition model according to an embodiment of the present disclosure. Taking the multiple encoding networks including 12 layers as an example, the multiple encoding networks may include the head encoding network (for example, the head encoding network may be an encoding network in any layer from Encoder Layer 1 to Encoder Layer 6 (corresponding to the first layer number interval)), the intermediate encoding network (for example, the intermediate encoding network may be an encoding network in any layer from Encoder Layer 7 to Encoder Layer 9 (corresponding to the second layer number interval)), and the tail encoding network (for example, the tail encoding network may be an encoding network in any layer from Encoder Layer 10 to Encoder Layer 12 (corresponding to the third layer number interval)).

Here, the preset phrases refer to phrases preset for specific fields or specific application scenarios, such as proper nouns, high-frequency terms, hot terms in the financial field and business terms (such as product names) in the financial scenario.

Following the above example, with reference to FIG. 3B, the operation 102 illustrated in FIG. 3A can be implemented by the following operations 1021 to 1022, which are specifically described as follows.

At the operation 1021, for a first encoding network among the multiple encoding networks, if the [0065] first encoding network is the head encoding network among the multiple encoding networks, attention processing is performed on the preset phrase(s) and the first encoded feature to obtain a first attention feature, and the first encoded feature and the first attention feature are fused to obtain the second encoded feature.

As stated above, the first encoded feature includes the first feature vectors corresponding to the multiple audio frames, in this case, the first attention feature includes first attention feature vectors corresponding to the multiple audio frames, and the second encoded feature includes second feature vectors corresponding to the multiple audio frames.

In some embodiments, the attention processing is performed on the preset phrase(s) and the first encoded feature to obtain the first attention feature, which may be implemented by the following manner including: performing encoding processing on the preset phrase(s) to obtain phrase feature(s); and performing attention encoding processing on the phrase feature(s) and the first encoded feature to obtain the first attention feature.

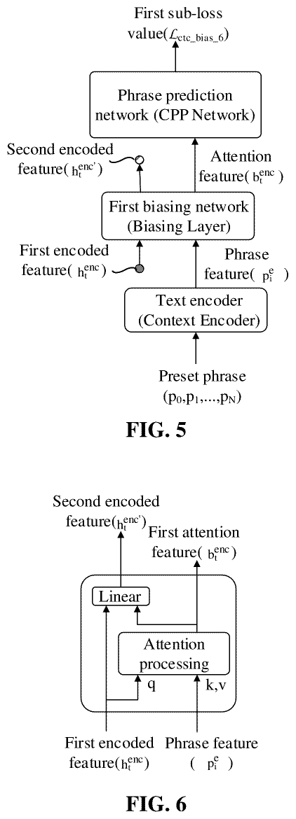

For example, with reference to FIG. 6, which is a structural diagram of a biasing network provided in an embodiment of the present disclosure, attention processing is performed based on the first encoded feature and the phrase feature(s) (obtained by encoding the preset phrase(s) through the text encoder illustrated in FIG. 5) of the preset phrase(s) to obtain the first attention feature, the first encoded feature and the first attention feature are fused (concatenated) and input to a linear layer, and the second encoded feature is output through linear mapping of the linear layer.

For example, the encoding processing is performed on the preset phrase(s) to obtain the phrase feature(s), which may be implemented by the following manner including: performing word embedding encoding (Token Embedding) processing on the preset phrase(s) to obtain word embedding feature(s), and then performing encoding processing on the word embedding feature(s) to obtain phrase feature(s).

For example, word embedding encoding processing can be performed on the preset phrase(s) through a word embedding model (such as Word2Vec, GloVe), where each preset phrase can be expressed as a vector with a fixed length, and the vector(s) are sequentially arranged to form word embedding feature(s) (sequence). Word embedding feature(s) can be encoded by the LSTM network to obtain phrase feature(s).

For example, the attention encoding processing is performed on the phrase feature(s) and the first encoded feature to obtain the first attention feature, which may be implemented by the following manner including: determining an attention score matrix based on the phrase feature(s) and the first encoded feature, and weighting the phrase feature(s) through the attention score matrix to obtain the first attention feature.

For example, the preset phrases includes multiple phrases (e.g., denoted as p₀, p₁, . . . , p_{N}), the first encoded feature (corresponding to hₜ^{enc} illustrated in FIG. 6, representing the first encoded feature corresponding to the audio frame of the t time step) is used as a Query vector (Q), and the phrase features of the multiple phrases (corresponding to the pᵢ^{e} illustrated in FIG. 6, representing the phrase feature of the i phrase) are used as both Key vectors (K) and Value vectors (V), attention scores for each of the multiple phrases are obtained by calculating the dot product of Q and K. Next, the attention scores are normalized, for example, by applying a normalization function (such as the softmax function), so that the attention scores for each of the multiple phrases become probability distributions, forming the attention score matrix.

Following the above example, the phrase features (corresponding to V) are weighted using the attention score matrix, to obtain the first attention feature (corresponding to bₜ^{enc} illustrated in FIG. 6, representing the attention feature corresponding to the audio frame of the t time step). The first attention feature includes attention features corresponding to respective audio frames in the audio data sample.

In some embodiments, the first encoded feature and the first attention feature are fused to obtain the second encoded feature, which may be implemented by the following manner including: concatenating the first attention feature and the first encoded feature, and linearly transforming a concatenated feature representation through the linear layer, to obtain the second encoded feature (corresponding to hₜ^{enc} illustrated in FIG. 6, representing the second encoded feature corresponding to the audio frame of the t time step).

In other embodiments, weighted summation is performed on the first attention feature and the first encoded feature based on preset weight coefficients, to obtain the second coding feature. The embodiments of the present disclosure do not limit the specific implementation for fusing the first attention feature and the first encoded feature.

At the operation 1022, if the first encoding network is any encoding network after the head encoding network, first phrase(s) are obtained by filtering from the preset phrases, attention processing is performed on the first phrase(s) and the first encoded feature to obtain a second attention feature, and the first encoded feature and the second attention feature are fused to obtain the second encoded feature.

As stated above, the first encoded feature includes the first feature vectors corresponding to the multiple audio frames, in this case, the second attention feature includes second attention feature vectors corresponding to the multiple audio frames, and the second encoded feature includes second feature vectors corresponding to the multiple audio frames.

As illustrated in FIG. 4, any encoding network after the head encoding network (such as the Encoder Layer 1 to the Encoder Layer 6 of the encoder) refers to any one of the intermediate encoding network (such as the Encoder Layer 7 to the Encoder Layer 9) or the tail encoding network (such as the Encoder Layer 10 to the Encoder Layer 12).

In some embodiments, the preset phrases includes multiple phrases. The first attention feature includes attention features corresponding to respective audio frames in the audio data sample. With reference to FIG. 3C, the operation 1022 (filtering from the preset phrases to obtain first phrase(s)) illustrated in FIG. 3B may be implemented by the following operations 10221 to 10223, which will be described in detail as follows.

At the operation 10221, for an attention feature (i.e., represented by an attention feature vector) corresponding to each audio frame, an attention score matrix corresponding to the attention feature is determined, where the attention score matrix includes attention scores for the multiple phrases.

Following the example in the operation 1021, for each audio frame, the first encoded feature output by the head encoding network is used as the query vector (Q), the phrase features of the multiple phrases are used as both the key vectors (K) and the value vectors (V), and the attention scores for each of the multiple phrases are obtained by calculating the dot product of Q and K.

At the operation 10222, a preset number of phrases are determined from the multiple phrases based on a descending order of the attention scores, and the preset number of phrases is determined as multiple second phrases corresponding to the each audio frame.

For example, for each audio frame, phrases having the top K (preset number) attention scores among the preset phrases are obtained as the multiple second phrases corresponding to the audio frame.

At the operation 10223, a set of second phrases corresponding to the respective audio frames is constructed, a number of occurrences of each of the second phrases in the set is counted, and second phrase(s) with the number of occurrences greater than a preset threshold are determined as the first phrase(s).

For example, assuming that the second phrases (3 second phrases) corresponding to the multiple audio frames (3 audio frames) are respectively expressed as {(frame 1: phrase c, phrase d, phrase b), (frame 2: phrase c, phrase a, phrase b), and (frame 3: phrase e, phrase d, phrase b)}, the set may be expressed as {phrase c, phrase d, phrase b, phrase c, phrase a, phrase b, phrase e, phrase d, phrase b}, and the second phrase with the number of the occurrences greater than the preset threshold (e.g., 2) is determined as the first phrase.

Through the operation 10221 to 10223, a two-stage filtering strategy of the attention mechanism and the occurrence frequency statistics is used to filter from the large number of preset phrases to obtain the first phrase(s). Firstly, the local correlation between the audio segments and the phrases is quantified by the frame-level attention score, and the top K candidates of each frame are selected (avoiding misjudgment per frame). Next, by performing cross-frame phrase occurrence frequency statistics, strongly semantically related phrases (first phrases) are retained, significantly reducing redundant computation (i.e., processing only the first phrases rather than all the preset phrases).

Continuing with reference to FIG. 3A, at the operation 103, the second encoded feature is decoded through a decoding network in the audio recognition model, to obtain a first text probability distribution.

In some embodiments, the second encoded feature is decoded through the decoding network to obtain the first text probability distribution. For example, the decoding network may be constructed by a Transformer Decoder structure. Here, the decoding process may be performed by superimposing multiple layers of the Transformer Decoder structures. The embodiments of the present disclosure do not limit the specific number of layers of the decoding network.

For example, the second encoded feature may be mapped to a dimension of a vocabulary size through a fully connected layer (Dense Layer), and the output after linear transformation is converted into the first text probability distribution through the Softmax function.

Here, the first text probability distribution represents the probability values of all possible sub-word units (such as characters, sub-words, words) under the condition of the given input (i.e., second encoded feature).

For example, the first text probability distribution may be represented as a vector with a length of K, where K is the vocabulary size, and each element corresponds to a probability of a text unit. If the vocabulary is [a, b, c, d, e], the first text probability distribution corresponding to the time step t may be: [0.7, 0.1, 0.05, 0.1, 0.05], indicating that the character “a” is most likely to be output at the time step (a probability of 70%).

At the operation 104, bias mapping is performed on the first text probability distribution based on the preset phrase(s) through a second biasing network in the audio recognition model, to obtain a second text probability distribution.

In some embodiments, attention processing is performed based on the first text probability distribution and the phrase feature(s) of the preset phrase(s) (obtained by encoding the preset phrase(s) through the text encoder illustrated in FIG. 5) to obtain an attention feature, the first text probability distribution and the attention feature are fused (concatenated) and input to a linear layer, and the second text probability distribution is output through the linear mapping of the linear layer.

Here, the specific implementation of the bias mapping can make reference to the description in the operation 102, which will not be repeated here.

At the operation 105, a loss value is determined based on text labels for the audio data sample, the first encoded feature(s), the first text probability distribution, and the second text probability distribution.

For example, with reference to FIG. 4, the loss value includes an encoding-side loss value and a decoding-side loss value, where the encoding-side loss value includes a first loss value, a second loss value, and a third loss value, and the decoding-side loss value includes a fourth loss value and a fifth loss value.

In some embodiments, the number of encoding networks is multiple. With reference to FIG. 3D, the operation 105 illustrated in FIG. 3A may be implemented by the following operations 1051 to 1055, which are specifically described as follows.

At the operation 1051, for a first encoding network among the multiple encoding networks, if the first encoding network is a head encoding network among the multiple encoding networks, a first loss value is determined based on the first encoded feature output by the head encoding network and the text labels.

For example, with reference to FIG. 4, the first loss value corresponding to the head encoding network includes a first sub-loss value (L_{ctc_bias_6}) and a second sub-loss value (L_{ctc_mid_6}).

In some embodiments, with reference to FIG. 3E, the operation 1051 illustrated in FIG. 3D may be implemented by the following operations 10511 to 10513, which are specifically described as follows.

At the operation 10511, the first sub-loss value is determined based on the first encoded feature output by the head encoding network and phrase labels, where the phrase labels include phrase(s) in the text labels matching the preset phrase(s).

In some embodiments, attention processing is performed on the preset phrase(s) and the first encoded feature output by the head encoding network to obtain an attention feature (which may make reference to the description in the operation 1021), and the first sub-loss value is determined based on the attention feature and the phrase labels.

For example, with reference to FIG. 5, which is a schematic diagram of a principle for calculating the first sub-loss value provided in an embodiment of the present disclosure, the preset phrase(s) are encoded through a text encoder (such as the LSTM network) to obtain phrase feature(s), attention processing is performed based on the phrase feature(s) and the first encoded feature (realized through the first biasing network) to obtain the attention feature, and the first sub-loss value is determined based on the attention feature and the phrase labels through a phrase prediction network.

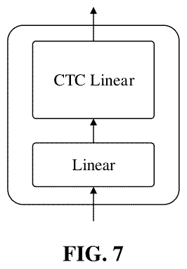

For example, with reference to FIG. 7, which is a structural diagram of a phrase prediction network provided in an embodiment of the present disclosure, the attention feature is linearly transformed through a Linear layer (Linear) in the phrase prediction network, to obtain a linearly transformed feature, and the first sub-loss value is determined based on the linearly transformed feature and the phrase labels through a Connectionist Temporal Classification Linear layer (CTC Linear).

Here, the phrase labels include phrase(s) matching the preset phrase(s) in the text labels. For example, if the text label is “I want to check ** hua repayment information” and the preset phrase(s) also include “** hua”, the phrase label is “** hua”.

Following the above example, the operation of determining the first sub-loss value based on the linearly transformed feature and the phrase labels can be expressed by formula (1):

$${L}_{ctc\_bias \_ 6} = - log {P}_{CTC} ( {y}_{P} \vert {x}_{A 1} ) \qquad ( 1 )$$

Herein, y_{P} represents the phrase label, x_{A1} represents the linearly transformed feature, and P_{CTC} represents the probability of predicting the phrase label y_{P} given the condition of x_{A1}. This probability is calculated through the CTC decoder (such as the CTC Linear in FIG. 7). The −log operation represents taking the negative logarithm of the probability, so that when the probability approaches 0, the loss value becomes very large. This helps impose greater weight on incorrect predictions during backpropagation.

It should be noted that the calculation method of the L_{ctc_bias_6} illustrated in the formula (1) is only an example of one implementation, and other loss calculation methods, such as CTC Spike Reduce, may also be used to reduce the number of spikes.

At the operation 10512, the second sub-loss value is determined based on the first encoded feature output by the head encoding network and the text labels.

In some embodiments, the second sub-loss value is calculated based on the first encoded feature output by the head encoding network and the text labels through a preset loss function, for example, the second sub-loss value L_{ctc_mid_6} can be expressed by formula (2):

$${L}_{ctc\_mid \_ 6} = - log {P}_{CTC} ( {Y}_{trans}^{label} \vert {h}_{N - 6}^{enc} ) \qquad ( 2 )$$

Herein,

$${Y}_{trans}^{label}$$

represents the text label,

$${h}_{N - 6}^{enc}$$

represents the first encoded feature output by the head encoding network, and P_{CTC} represents the probability of predicting the sequence

$${Y}_{trans}^{label}$$

given the condition of

$${h}_{N - 6}^{e n c} ,$$

where this probability is calculated by the CTC decoder.

At the operation 10513, the first sub-loss value and the second sub-loss value are fused to obtain the first loss value.

In some embodiments, the first sub-loss value and the second sub-loss value are weighted and summed based on preset weights, to obtain the first loss value.

Continuing with reference to FIG. 3D, at the operation 1052, if the first encoding network is an intermediate encoding network among the multiple encoding networks, a second loss value is determined based on the first encoded feature output by the intermediate encoding network, the first text probability distribution, and the text labels.

For example, with reference to FIG. 4, the second loss value corresponding to the intermediate encoding network includes a third sub-loss value (L_{ctc_bias_9}), a fourth sub-loss value (L_{ctc_pre_9}) and a fifth sub-loss value (L_{sha_pre_dec_9}).

In some embodiments, with reference to FIG. 3F, the operation 1052 illustrated in FIG. 3D may be implemented by the following operations 10521 to 10524, which are specifically described as follows.

At the operation 10521, the third sub-loss value is determined based on the first encoded feature output by the intermediate encoding network and phrase labels, where the phrase labels include phrase(s) in the text labels matching the preset phrase(s).

In some embodiments, attention processing is performed on the preset phrase(s) and the first encoded feature output by the intermediate encoding network, to obtain an attention feature, and the third sub-loss value (L_{ctc_bias_9}) is determined based on the attention feature and the phrase labels.

Here, specific implementations can make reference to the description in the operation 10511 above, which will not be repeated here.

At the operation 10522, the first encoded feature output by the intermediate encoding network and the first text probability distribution are fused to obtain a third encoded feature, and the fourth sub-loss value is determined based on the third encoded feature and the text label.

In some embodiments, the first encoded feature output by the intermediate encoding network and the first text probability distribution are concatenated, and the concatenated feature is linearly mapped (which may be implemented by the linear layer), to obtain the third encoded feature, and the fourth sub-loss value is calculated based on the third encoded feature and the text labels through a preset loss function. For example, the fourth sub-loss value L_{ctc_pre_9} can be expressed by formula (3):

$${L}_{ctc \_ pre \_ 9} = - log {P}_{CTC} ( {Y}_{t r a n s}^{labe1} \vert {x}_{E 9} ) \qquad ( 3 )$$

Herein,

$${Y}_{t r a n s}^{label}$$

represents the text label, x_{E9} represents the third encoded feature, and P_{CTC} represents the probability of predicting the sequence

$${Y}_{t r a n s}^{label}$$

given the condition of x_{E9}, where this probability is calculated through the CTC decoder.

At the operation 10523, the first encoded feature output by the intermediate encoding network is decoded through the decoding network in the audio recognition model, to obtain a third text probability distribution, and the fifth sub-loss value is determined based on the third text probability distribution and the text label.

In some embodiments, the first encoded feature output by the intermediate encoding network is decoded through the decoding network, to obtain the third text probability distribution. For example, the decoding network may be constructed by a Transformer Decoder structure. Here, the decoding process may be performed by superimposing multiple layers of the Transformer Decoder structures. The embodiments of the present disclosure do not limit the specific number of layers of the decoding network.

For example, the first encoded feature output by the intermediate encoding network may be mapped to the dimension of the vocabulary size through a fully connected layer (Dense Layer), and the output after linear transformation is converted into the third text probability distribution through the Softmax function.

In some embodiments, the fifth sub-loss value is determined based on the third text probability distribution and the text labels through a preset loss function. For example, the fifth sub-loss value L_{sha_pre_dec_9} can be expressed by formula (4):

$${L}_{sha \_ pre \_ dec \_ 9} = label\_smoothing \_loss ( linear ( {h}_{N - 9}^{e n c} ) , {Y}_{t r a n s}^{label} ) \qquad ( 4 )$$

Herein, label_smoothing_loss(⋅) represents the label-smoothing cross-entropy loss,

$$( {h}_{N - 9}^{e n c} )$$

represents the first encoded feature output by the intermediate encoding network, linear

$$( {h}_{N - 9}^{enc} )$$

represents the third text probability distribution, and

$${Y}_{t r a n s}^{label}$$

represents the text label.

For example, given the third probability distribution at each time step (the third text probability distribution includes the probability distribution per time step). For example, the probability {0.2, 0.3, 0.4, 0.1} for each token in the vocabulary (e.g., 4 tokens including a, b, c, and d) is output at the time step 1. If the text label corresponding to the current time step 1 is “b”, then the probability distribution of the text label is {0, 1, 0, 0}. The label-smoothing cross-entropy loss between {0.2, 0.3, 0.4, 0.1} and {0, 1, 0, 0} is calculated, and so on. The respective losses corresponding to all time steps are calculated, and the average of these losses is taken as the fifth sub-loss value.

At the operation 10524, the third sub-loss value, the fourth sub-loss value, and the fifth sub-loss value are fused to obtain the second loss value.

In some embodiments, the third sub-loss value, the fourth sub-loss value, and the fifth sub-loss value are weighted and summed based on preset weights, to obtain the second loss value.

According to the operations 10521 to 10524, the first text probability distribution is incorporated into the loss computation in the intermediate encoding network, and the prediction result from the decoding stage is fed back into the encoding process, facilitating bidirectional information interaction between the encoder and decoder, and enhancing the ability of the model in modeling contextual dependencies.

Continuing with reference to FIG. 3D, at the operation 1053, if the first encoding network is a tail encoding network among the multiple encoding networks, the third loss value is determined based on the first encoded feature output by the tail encoding network, the text label, and the second encoded feature (obtained by performing bias mapping on the first encoded feature output by the tail encoding network).

In some embodiments, a sixth sub-loss value is determined based on the first encoded feature output by the tail encoding network and phrase labels, where the phrase labels include phrase(s) in the text labels matching the preset phrase(s) (which may make reference to the description in the operation 10511). A seventh sub-loss value is determined based on the second encoded feature obtained by performing feature mapping on the first encoded feature output by the tail encoding network and the text labels (which may make reference to the description in the operation 10512, corresponding to calculating the probability of predicting the sequence

$${Y}_{t r a n s}^{label}$$

given the second encoded feature obtained by performing feature mapping on the first encoded feature output by the tail encoding network). The sixth sub-loss value and the seventh sub-loss value are fused to obtain the third loss value (which may make reference to the description in the operation 10513).

At the operation 1054, the encoding-side loss value is determined based on the first loss value, the second loss value, and the third loss value, and the decoding-side loss value is determined based on the first text probability distribution, the second text probability distribution, and the text label.

In some embodiments, the encoding-side loss value can be expressed as formula (5):

$${L}_{enc \_ total} = λ {L}_{bias \_ enc} + {L}_{e n c} \qquad ( 5 )$$

Herein, λ represents a preset weight coefficient.

Following the above example, L_{bias_enc} can be expressed by formula (6):

$${L}_{bias \_ enc} = α {L}_{ctc \_ bias \_ 6} + α {L}_{ctc \_ bias \_ 9} + ( 1 - α ) {L}_{ctc \_ bias \_ 12} \qquad ( 6 )$$

Herein, α represents a preset weight coefficient, L_{ctc_bias_6} represents the first sub-loss value of the first loss value, L_{ctc_bias_9} represents the third sub-loss value of the second loss value, and L_{ctc_bias_12} represents the sixth sub-loss value of the third loss value.

Following the above example, L_{enc} can be expressed by formula (7):

$${L}_{e n c} = {L}_{ctc \_ mid \_ 6} + {L}_{ctc \_ pre \_ 9} + {L}_{sha \_ pre \_ dec \_ 9} + {L}_{ctc \_ enc \_ 12} \qquad ( 7 )$$

Herein, L_{ctc_mid_6} represents the second sub-loss value of the first loss value, L_{ctc_pre_9} represents the fourth sub-loss value of the second loss value, L_{sha_pre_dec_9} represents the fifth sub-loss value of the second loss value, and L_{ctc_enc_12} represents the seventh sub-loss value of the third loss value.

It is noted that formulas (5) to (7) are merely examples of one implementation for determining the encoding-side loss value, and the embodiments of the present disclosure do not limit the specific loss value calculation method.

In some embodiments, the decoding-side loss value is determined based on the first text probability distribution, the second text probability distribution, and the text label, which may be implemented by the following manner including: determining the fourth loss value based on the first text probability distribution and the text label; determining the fifth loss value based on the second text probability distribution and the text label; and fusing the fourth loss value and the fifth loss value to obtain the decoding-side loss value.

For example, with reference to FIG. 4, the decoding-side loss value includes the fourth loss value and the fifth loss value, and the decoding-side loss value can be expressed by formula (8):

$${L}_{dec \_ total} = α {L}_{bias \_ dec} + {L}_{d e c} \qquad ( 8 )$$

Herein, L_{bias_dec} represents the fourth loss value, L_{dec} represents the fifth loss value, and a represents a preset weight coefficient.

Following the above example, L_{dec} can be expressed by formula (9):

$${L}_{d e c} = label\_smoothing \_loss ( linear ( {h}_{N}^{d e c} ) , {Y}_{t r a n s}^{label} ) \qquad ( 9 )$$

Herein, linear

$$( {h}_{N}^{d e c} )$$

represents the first text probability distribution,

$${Y}_{trans}^{label}$$

represents the text label, and label_smoothing_loss(⋅) represents the label-smoothing cross-entropy loss.

Following the above example, L_{bias_dec} can be expressed by formula (10):

$${L}_{bias \_ dec} = label\_smoothing \_loss ( linear ( {h}_{N}^{{dec}^{′}} ) , {Y}_{trans}^{label} ) \qquad ( 10 )$$

Herein, linear

$$( {h}_{N}^{{dec}^{′}} )$$

represents the second text probability distribution,

$${Y}_{trans}^{label}$$

represents the text label, and label_smoothing_loss(⋅) represents the label-smoothing cross-entropy loss.

It is noted that formulas (8) to (10) are merely examples of one implementation for determining the decoding-side loss value, and the embodiments of the present disclosure do not limit the specific loss value calculation method.

At the operation 1055, the encoding-side loss value and the decoding-side loss value are fused to obtain the loss value.

In some embodiments, the encoding-side loss value and the decoding-side loss value are weighted and summed based on preset weight coefficients, to obtain the loss value.

Through the operations 1051 to 1054, multi-level joint loss value calculation is realized. Specifically, by designing differentiated loss calculation strategies for the head, intermediate and tail encoding networks, respectively (for example, the head/tail encoding network focuses on basic feature alignment, and the intermediate encoding network introduces the decoding-side text probability distribution as a supervisory signal), targeted optimization for features in different layers of the encoding network is realized, ensuring that the shallow network captures acoustic details and the deep network focuses on semantic context, and finally achieving the beneficial effect of improving the audio recognition accuracy.

Continuing with reference to FIG. 3A, at the operation 106, parameters of the audio recognition model are updated (e.g., tuned) based on the loss value, to obtain a trained audio recognition model.

In some embodiments, gradient information is obtained based on the loss value, and parameters of each network in the audio recognition model are updated (e.g., tuned) based on the gradient information, to obtain the trained audio recognition model.

For example, gradient information of the loss value with respect to each parameter of the audio recognition model is obtained through the backpropagation algorithm. According to a gradient descent optimization algorithm (such as batch gradient descent, stochastic gradient descent), the parameters of the audio recognition model are updated (e.g., tuned) based on the obtained gradient information. This process is repeated until a certain number of iterations is reached or the audio recognition model converges, thereby obtaining the trained audio recognition model.

According to the operations 101 to 106, by introducing a first biasing network into the audio recognition model, bias mapping is performed on the first encoded feature obtained through encoding processing based on preset phrase(s), the audio recognition model is guided to pay attention to specific vocabularies (i.e. the preset phrases). By introducing a second biasing network, bias mapping is performed on the first text probability distribution obtained after performing decoding processing, the recognition for the preset phrase(s) is further optimized. By a design of a loss value that integrates multiple supervision signals from the first encoded feature, the first text probability distribution, the second text probability distribution and the text label, the audio recognition model achieves enhanced semantic focus capability and robustness, thereby improving the audio recognition accuracy.

In some embodiments, after obtaining the trained audio recognition model, audio recognition may be performed on audio data to be recognized based on the trained audio recognition model, to obtain a first text corresponding to the audio data to be recognized.

In some embodiments, with reference to FIG. 3G, the audio recognition is performed on the audio data to be recognized based on the trained audio recognition model, to obtain the first text corresponding to the audio data to be recognized, which may be implemented through the following operations 201 to 206. The operations 201 to 206 will be described in detail below.

At the operation 201, the audio data to be recognized is encoded through encoding network(s) in the trained audio recognition model, to obtain third encoded feature(s).

In some embodiments, framing processing is performed on the audio data to be recognized to obtain audio frames; frequency domain transformation processing is performed on the audio frames to obtain a frequency domain representation for the audio frames; acoustic feature extraction processing is performed on the frequency domain representation to obtain spectrum features; and feature encoding processing performed on the spectrum features to obtain the third encoded feature.

Here, the specific implementation can make reference to the description of the operation 101, which will not be repeated here.

At the operation 202, bias mapping is performed on the third encoded feature(s) based on the preset phrase(s) through a first biasing network in the trained audio recognition model, to obtain fourth encoded feature(s).

In some embodiments, the number of encoding networks is multiple. For a first encoding network among the multiple encoding networks, if the first encoding network is the head encoding network among the multiple encoding networks, attention processing is performed on the preset phrase(s) and the third encoded feature to obtain a third attention feature, and the third encoded feature and the third attention feature are fused to obtain the fourth encoded feature (which may make reference to the description of the operation 1021). If the first encoding network is any encoding network after the head encoding network, first phrase(s) are obtained by filtering from the preset phrases, attention processing is performed on the first phrase(s) and the third encoded feature to obtain a fourth attention feature, and the third encoded feature and the fourth attention feature are fused to obtain the fourth encoded feature (which may make reference to the description of the operation 1022).

At the operation 203, the fourth encoded feature is decoded through a decoding network in the trained audio recognition model, to obtain a fourth text probability distribution.

In some embodiments, the fourth encoded feature is decoded through the decoding network to obtain the fourth text probability distribution. For example, the decoding network may be constructed by a Transformer Decoder structure. Here, the decoding process may be performed by superimposing multiple layers of the Transformer Decoder structures. The embodiments of the present disclosure do not limit the specific number of layers of the decoding network.

For example, the fourth encoded feature may be mapped to the dimension of the vocabulary size through a fully connected layer (Dense Layer), and the output after linear transformation is converted into the fourth text probability distribution through the Softmax function.

Here, the fourth text probability distribution represents the probability values of all possible text units (such as characters, sub-words, words) given the input fourth encoded feature.

At the operation 204, bias mapping is performed on the fourth text probability distribution based on the preset phrase(s) through a second biasing network in the trained audio recognition model, to obtain a fifth text probability distribution.

In some embodiments, attention processing is performed based on the fourth text probability distribution and the phrase feature(s) of the preset phrase(s) (obtained by encoding the preset phrase(s) through the text encoder illustrated in FIG. 5) to obtain an attention feature, the fourth text probability distribution and the attention feature are fused (concatenated) and input to a linear layer, and the fifth text probability distribution is output through linear mapping of the linear layer.

Here, the specific implementation of the bias mapping can make reference to the description in the operation 102, which will not be repeated here.

At the operation 205, multiple second texts are generated based on the fifth text probability distribution.

In some embodiments, a fixed size (beam width) set of candidate text sequences is maintained through Beam Search. At each time step, all candidate text sequences are expanded based on the fifth text probability distribution, and their cumulative probabilities (or the sum of logarithmic probabilities) are calculated. The top k candidate text sequences with the highest cumulative probabilities are retained. Through layer-by-layer expansion and dynamic pruning, multiple candidate text sequences with high probabilities are finally output as the second texts.

At the operation 206, the multiple second texts are filtered to obtain the first text based on first evaluation scores of the multiple second texts.

In some embodiments, the second text with the highest first evaluation score among the multiple second texts is determined as the first text.

According to the operations 201 to 206, the fourth text probability distribution is fused with attention based on the preset phrase(s) via the second biasing network, where this process dynamically adjusts the probability distribution using phrase features generated through the text encoder, significantly enhancing the recognition sensitivity of the model to the preset phrases. Multiple candidate sequences are maintained through Beam Search, avoiding the local optimum issue caused by single greedy decoding, and improving the semantic plausibility and domain adaptability of the output text. Candidate texts are further filtered based on the first evaluation scores, effectively balancing the recognition accuracy and the semantic fluency, and reducing the risk of misrecognition or logical errors.

In some embodiments, with reference to FIG. 3H, before filtering from the multiple second texts to obtain the first text based on the first evaluation scores of the multiple second texts, the following operations 301 to 304 may be further performed, which will be described in detail below.

At the operation 301, for each of the multiple second texts, an alignment degree between the second text and the audio data to be recognized is scored based on the second text and the fourth encoded feature, to determine a second evaluation score.

In some embodiments, the second evaluation score S_{ctc} can be expressed by formula (11):

$${S}_{ctc} = {\sum }_{t = 1}^{T} log P ( {y}_{t} \vert {x}_{t} ) \qquad ( 11 )$$

Herein, xₜ represents the fourth encoded feature corresponding to a t-th audio frame in the audio data to be recognized, and yₜ represents the label at the t-th frame in the CTC alignment path, corresponding to the second text.

Here, S_{ctc} score is used to evaluate whether each word in the second text (such as “ni hao”) matches the second encoded feature of the corresponding time period in the audio data to be recognized. For example, if the fifth to tenth frames in the audio data to be recognized are the pronunciation of “ni”, and “ni” appears at the third position in the second text, the matching degree between these frames and “ni” is calculated through S_{ctc}.

For example, the second text (such as “ni hao”) is expanded into possible alignment paths (such as “ni-ni-blank-hao-hao”) according to the CTC rule. For each time step, the probability P(yₜ|xₜ) is calculated. The probabilities for all the frames are summed after taking the logarithm (to avoid numerical underflow), yielding the final S_{ctc} score. For example, the second encoded features corresponding to the 5 audio frames are represented as: x₁, x₂, x₃, x₄, x₅, then S_{ctc} score can be expressed as:

$$log P ( ni \vert {x}_{1} ) + log P ( ni \vert {x}_{2} ) + log P ( blank \vert {x}_{3} ) + log P ( hao \vert {x}_{4} ) + log P ( hao \vert {x}_{5} ) .$$

At the operation 302, for each of the multiple second texts, semantic coherence of the second text is scored based on the second text and the fourth encoded feature, to determine a third evaluation score.

In some embodiments, the third evaluation score S_{dec} can be expressed by formula (12):

$${S}_{dec} = {\sum }_{i = 1}^{L} log P ( {w}_{i} \vert {w}_{1 : i - 1} , {H}_{enc} ) \qquad ( 12 )$$

Herein, wᵢ represents the i-th word in the second text, w_{1:i-1} represents the first i−1 words that have been generated, H_{enc} represents the fourth encoded feature.

Here, S_{dec} score is used to evaluate whether the second text is fluent and reasonable, and whether the second text conforms to language habits. For example, the second text “collect application” has a lower S_{dec} score due to the awkward collocation of “collect” and “application”, while “cellphone application” is more in line with everyday expression, thus has a higher S_{dec} score.

For example, assuming that the second text is “qing dian ji shou ji ying yong”, when the second text is generated word by word, the probability of generating “qing” can be expressed as P(qing|blank, H_{enc}), the probability of generating “dian” can be expressed as P(dain|qing, H_{enc}), the probability of generating “ji” can be expressed as P(ji|qing dian, H_{enc}), and so on, thereby obtaining the probability corresponding to each word. The probabilities for all the words are summed after taking the logarithm, yielding the S_{ctc} score.

At the operation 303, for each of the multiple second texts, correlation between the second text and the preset phrase(s) is scored based on the second text and the preset phrase(s), to determine a fourth evaluation score.

In some embodiments, the fourth evaluation score S_{bias_dec} can be expressed by formula (13):

$${S}_{bias \_ dec} = {\sum }_{k ∈ Bias \_ Phrases} log {P}_{bias} ( k \vert {H}_{dec} ) \qquad ( 13 )$$

Herein, k represents a phrase among the preset phrases, Bias_Phrases represents the preset phrases, H_{dec} represents the fifth text probability distribution, and P_{bias}(k|H_{dec}) represents the probability of the occurrence of k in the second text, where this probability value can be calculated through the CPP Network.

Here, S_{bias_dec} score is used to check whether the second text contains the preset phrase(s) (e.g., “** hua”) and “increases the score” for the occurrence of these phrases. For example, if the preset phrase(s) contain “** hua”, the occurrence of “** hua” in the second text significantly improves the S_{bias_dec} score for the second text.

At the operation 304, the second evaluation score, the third evaluation score, and the fourth evaluation score are fused to determine the first evaluation score.

In some embodiments, the first evaluation score S_{final} can be expressed by formula (14):

$${S}_{final} = γ {S}_{ctc} + φ {S}_{dec} + ( 1 - γ - φ ) {S}_{bias \_ dec} \qquad ( 14 )$$

Herein, S_{ctc} represents the second evaluation score, S_{dec} represents the third evaluation score, and S_{bias_dec} represents the fourth evaluation score.

It should be noted that the S_{ctc} and S_{dec} scores can also be calculated using the method illustrated in the Unified Two-pass Bidirectional End-to-end Model for Speech Recognition (U2++), which is not limited in the embodiments of the present disclosure.

According to the operations 301 to 304, the text filtering mechanism of multi-dimensional joint optimization is realized, and the beneficial effect of balancing speech alignment accuracy, semantic rationality and service requirement adaptability is achieved. Specifically, the S_{ctc} score is used to evaluate the temporal alignment relationship between the second text and the audio frame to avoid local misalignment problems caused by the global dependency of the attention mechanism (Attention). By using the S_{dec} score, prior knowledge from the language model is introduced for filtering out texts with grammatical errors or semantic contradictions. By using the S_{bias_dec} score, the weight(s) of the preset phrase(s) (such as “** hua”) are injected into the scoring system, thereby improving the adaptability of the audio recognition to the service requirement.

In related technologies, the end-to-end speech recognition system based on neural networks has made significant progress. However, the recognition accuracy drops significantly for rare terms or specific contextual terms (such as proper nouns) not included in the training dataset. Previous research has attempted to improve the performance of Automatic Speech Recognition (ASR) on rare phrases through Language Model (LM) fusion. Although this method enhances the recognition of relevant vocabulary, improvements to the bias list remain limited. Although the language model fusion can optimize contextual outputs, it does not significantly boost overall performance, especially when handling phrases that are outside the training set.

Neural network-based deep biasing methods have been proposed in related technologies, aiming to optimize the prediction of specific phrases by integrating lexical knowledge from training data into the speech recognition network. However, these methods typically only attach the bias vector to the last layer of the network. Many studies have attempted to inject deep bias into intermediate layers of the encoder. Among them, certain approaches use only the outputs of these intermediate encoder layers as context queries, and the resulting context embedding is still integrated with the final output of the encoder at the last layer. Although some methods have explored strategies for injecting contextual information at earlier layers, they do not introduce any additional shared text supervision loss beyond the bias loss.

The method for training the audio recognition model provided in the embodiments of the present disclosure has the following advantages.

### 1) Shared Intermediate Encoder Biasing Network (Corresponding to the First Biasing Network)

The embodiments of the present disclosure provide a shared intermediate encoder biasing network. By introducing a neural bias cross-attention mechanism in the 6-th, 9-th and 12-th layers of the SEQ-former encoder (corresponding to the encoding networks above) and combining the multi-layer loss supervision method, improvements to the multi-layer bias enhancement and parameter sharing supervision of the audio embedding are realized, and the effects of effectively utilizing the prior parameters of the SEQ-former, enhancing the function of the biasing module and optimizing the multi-layer embedding information sharing are achieved.

### 2) Biasing Decoder Network Sharing Attention Loss (Corresponding to the Second Biasing Network)

Embodiments of the present disclosure provide a biasing decoder network sharing attention loss. By integrating the Biasing Decoder Network into a decoder (corresponding to the decoding network above) and introducing a method for sharing attention loss, efficient modeling of the semantic context and improvement of focus on phrase information are realized, and effects of enhancing phrase recognition accuracy and optimizing decoder prediction performance are achieved. Moreover, by combining with comprehensive strategies of CTC decoding scoring, decoder scoring and bias decoder scoring, the final text prediction accuracy is further improved.

3) Shared Biasing Attention Phrase Filtering (Corresponding to the Operation of Filtering from the Preset Phrases to Obtain First Phrase(s))

Embodiments of the present disclosure provide shared biasing attention phrase filtering. By using the shared biasing attention phrase filtering method, efficient filtering for a large-scale phrase list and improvement to attention concentration are realized, and effects of reducing performance degradation, improving recognition accuracy, and accelerating decoding are achieved. Moreover, by replacing the Multi-Head Attention (MHA) mechanism with the Multi-Head Latent Attention (MLA) mechanism, the support and processing efficiency of the ultra-long input are further enhanced.

According to the method for training the audio recognition model provided by the embodiments of the present disclosure, the performance and generalization capability of the audio recognition system are significantly improved, enabling the audio recognition system to maintain high accuracy and high efficiency in different fields and complex scenarios.

Hereinafter, a specific implementation of the method for training the audio recognition model provided by the embodiments of the present disclosure will be described.

### 1) Shared Intermediate Encoder Biasing Network

As illustrated in FIG. 4, for a 12-layer SEQ-former encoder network (corresponding to the encoding networks above), the output is extracted from the 6-th, 9-th and 12-th layers, and after performing layer normalization, the audio embedding

$${h}_{t}^{enc \_ 6} ($$

(corresponding to the first encoded feature output by the head encoding network),

$${h}_{t}^{enc \_ 9} ($$

(corresponding to the first encoded feature output by the intermediate encoding network) and

$${h}_{t}^{enc \_ 12} ($$

(corresponding to the first encoded feature output by the tail encoding network) are obtained. These embeddings are combined with Pe (corresponding to the phrase feature(s) of the preset phrase(s)), after being processed by the neural bias cross-attention mechanism (i.e., the attention processing in FIG. 6), element-wise addition is performed to form the audio embedding with bias including hₜ^{enc'_6} (i.e., the second encoded feature obtained by performing bias mapping on the first encoded feature output by the head encoding network), hₜ^{enc'_9} (i.e., the second encoded feature obtained by performing bias mapping on the first encoded feature output by the intermediate encoding network) and hₜ^{enc'_12} (i.e., the second encoded feature obtained by performing bias mapping on the first encoded feature output by the tail encoding network). Herein, the neural bias cross-attention mechanism through which hₜ^{enc'_6} passes may be the MLA mechanism or the MHA mechanism, which is not limited by the embodiments of the present disclosure.

During training, the encoder bias enhancement loss is used to enhance supervision of the model over the biasing module, preventing the audio recognition model from ignoring the influence of the parameters of the biasing module. Additionally, all loss terms in the SEQ-former are retained. These loss terms provide shared supervision to the biasing network after incorporating the bias. The total loss of the encoder (corresponding to the encoding-side loss value) can be expressed by formula (15):

$${L}_{enc \_ total} = λ {L}_{bias \_ enc} + {L}_{SEQ - former \_ enc \_ total} \qquad ( 15 )$$

Herein, L_{SEQ-former_enc_total} represents the total loss of the encoder in the SEQ-former, including an intermediate layer loss L_{ctc_mid_6}, a CTC loss L_{ctc_enc_12}, a prediction decoder network supervision loss L_{ctc_pre_9}, and shared prediction decoder network loss L_{sha_pre_dec_9}. L_{bias_enc} includes the losses of audio embedding with a bias at the 6-th, 9-th and 12-th layers, and the calculation method for the L_{bias_enc} can make reference to the description of the formula (6). Here, all terms ending in numbers represent the output of the corresponding encoding network layer.

Following the above example, the calculation method for L_{ctc_mid_6} can make reference to the description of the formula (2). The calculation method for L_{ctc_pre_9} can make reference to the description of the formula (3). The calculation method for L_{sha_pre_dec_9} can make reference to the description of the formula (4). The calculation method for L_{ctc_enc_12} (corresponding to the seventh sub-loss value) can make reference to the description of the operation 1053.

Due to loss sharing and decoder parameter sharing, the biasing network effectively use the parameters pre-shared in the SEQ-former and maintains supervision by sharing losses, thereby enhancing the multi-layer embedding information in the form of sharing supervision.

### 2) Biasing Decoder Network Sharing Attention Loss

The accurate phrase recognition (i.e. recognizing the preset phrases) requires the combination of both acoustic and semantic contexts. Guided by the attention loss, the decoder is capable of efficiently modeling the semantic contexts. Therefore, by sharing the attention loss, a biasing decoder network (corresponding to the second biasing network above), such as the second biasing network illustrated in FIG. 4, is integrated into the decoder (corresponding to the decoding network above). The learning goal of the biasing decoder network is to transcribe a label (corresponding to the text label), and the label-smoothing cross-entropy loss is used as a loss function to achieve accurate phrase recognition based on the semantic context of the decoder. The loss function of the bias decoder can be expressed by the formula (10) above. Here,

$${Y}_{trans}^{label}$$

represents the audio transcription content (text label) of the current batch,

$${h}_{N}^{{dec}^{′}}$$

represents the weighted sum of the bias decoder attention mechanism (i.e., the attention feature obtained after input the output of the decoder (such as the Transformer Decoder) into the bias decoder (the second biasing network)), and N is the number of transcription labels in this batch. All phrases in each batch are consistent with those in the encoder, and this loss design aims to enhance the phrase information in semantic modeling, making the prediction of the decoder more focused on the bias information. The learning goal is the final text with the aim of improving prediction accuracy by introducing phrase biasing.

The total loss of the decoder (corresponding to the decoding-side loss value above) can make reference to the description of the formula (8).

It should be noted that during the inference phase of the audio recognition model, the CPP network component within the decoder is not discarded (the CPP network connected to the encoder is used only during training). Instead, the posterior probability score output by the CPP network (corresponding to P_{bias}(k|H_{dec}) in the formula (13)) is utilized to integrate phrase decoding into the attention rescoring mechanism, with an adjustable weight introduced to obtain the final score (corresponding to the first evaluation score above). The calculation formula for the final score can make reference to the description of the formula (14).

### 3) Shared Biasing Attention Phrase Filtering

When processing a huge phrase list, bias enhancement strategies in the related technologies usually face performance degradation due to attention dispersion. Thanks to the attention map (corresponding to the attention score matrix in the operation 10221) in the intermediate biasing network (the first biasing network), it can explicitly indicate the relationship between each speech frame and each phrase, enabling the selection of the top-k phrases for each frame (corresponding to the operation 10222 of determining a preset number of phrases from the multiple phrases based on a descending order of the attention scores, and determining the preset number of phrases as multiple second phrases corresponding to the each audio frame). Then, the numbers of occurrences of the phrases are counted in all the frames, and the phrase(s) with the number of occurrences exceeding n are regarded as key phrase(s) (corresponding to the operation 10223 of constructing a set of second phrases corresponding to the respective audio frames, counting the number of occurrences of each of the second phrases in the set, and determining second phrase(s) with the number of occurrences greater than a preset threshold as the first phrase(s)). These phrases (first phrases) are further extracted for bias embeddings (corresponding to the bias mapping above) and passed to subsequent biasing networks, thereby focusing attention and improving recognition accuracy. The 6-th layer (head encoding network) is selected for bias filtering, because earlier layers usually provide finer low-level information, while the 6-th layer is capable of effectively controlling the effect of a long list on speed.

Hereinafter, data and experimental results of the method for training the audio recognition model provided by the embodiments of the present disclosure will be described.

### 1) Data

The LibriSpeech dataset and a private 11,000-hour Chinese telephone audio training set are used, and the time period of the test set is 10.32 hours. For the LibriSpeech dataset, training was performed on the full dataset, and dev-clean/other is used for validation and test-clean/other is used for evaluation. During the training of the biasing network, Byte Pair Encoding (BPE) is employed to randomly extract phrases consisting of 1-3 words from each speech transcript as positive samples, and 57 unseen phrases are selected as negative samples to simulate interference. During the test phase, scenario phrase lists are used, with list lengths ranging from 100 to 2000. For the private dataset, a character modeling approach is adopted, where 2-8 characters are randomly selected from each transcript as positive samples. Meanwhile, a list containing 100,000 phrases is constructed to verify the effectiveness of the shared biasing attention phrase filtering. All other settings are kept consistent with the configuration used for the LibriSpeech dataset.

The biasing network has an attention dimension of 384, including 8 attention heads and 2048 Feedforward Neural Network (FFN) units. The biasing network includes a single-layer Bidirectional Long Short-Term Memory (BLSTM) encoder with 384-dimension (corresponding to the text encoder illustrated in FIG. 5), two linear layers, and an 8-head attention layer for incorporating the biasing.

With reference to FIG. 7, the first linear layer in the CPP Network (Linear illustrated in FIG. 7) adopts a tanh activation function and maintains the 384-dimensional output, while the second linear layer (CTC Linear illustrated in FIG. 7) projects the input to the vocabulary size and shares parameters with the CTC layer of the SEQ-former encoder. Due to different training goals, the bias decoding network (the second biasing network) and the bias encoding network (the first biasing network) share the structure but do not share the parameters, that is, the first biasing network and the second biasing network have the same network structure and different network parameters.

Word Error Rate (WER), Biased Word Error Rate (B-WER, for words in the bias list), and Unbiased Word Error Rate (U-WER, for words not in the bias list) were used as evaluation indicators. The SEQ-former-M model trained on LibriSpeech and private telephone data is used as the baseline, the parameters of the SEQ-former-M model are frozen during the training of the biasing network. The Adam optimizer is used with an initial learning rate of 0.001, 50 epoches were trained on the LibriSpeech data and 10 epoches were trained on the private data.

### 2) Experimental Results and Analysis

The experimental results on the librispeech dataset are as follows.

TABLE 1

| | N = 100 | | N = 500 | | N = 1000 | |
|---|---|---|---|---|---|---|
| Method | Test-clean | Test-other | Test-clean | Test-clean | Test-clean | Test-clean |
| CPPN | 3.4 | 7.77 | 3.68 | 8.31 | 3.81 | 8.75 |
| | (2.6/10.4) | (6.0/23.0) | (2.8/10.9) | (6.5/24.3) | (2.9/11.4) | (6.9/25.3) |
| ECI-TP | 1.24 | 3.32 | 1.50 | 3.69 | 1.74 | 4.24 |
| | (1.11/2.29) | (3.08/5.46) | (1.24/3.56) | (3.18/8.19) | (1.33/5.10) | (3.49/10.84) |
| Conformer + SI | 2.82 | 7.02 | 2.98 | 7.28 | 3.22 | 7.85 |
| | (2.17/8.12) | (5.84/17.42) | (2.30/8.47) | (5.88/19.65) | (2.43/9.65) | (6.32/21.37) |
| Conformer + SD + SI | 2.29 | 6.57 | 2.42 | 6.90 | 2.47 | 7.20 |
| | (1.82/6.09) | (5.56/15.51) | (1.90/6.59) | (5.75/17.08) | (1.93/6.84) | (5.93/18.37) |
| Method according to the | 1.47 | 3.66 | 1.67 | 3.95 | 1.79 | 4.31 |
| embodiment of the present | (1.11/4.35) | (3.09/8.72) | (1.21/5.38) | (3.15/11.01) | (1.24/6.21) | (3.35/12.76) |
| disclosure + SI | | | | | | |
| Method according to the | 1.26 | 3.31 | 1.56 | 3.66 | 1.73 | 4.18 |
| embodiment of the present | (1.14/2.25) | (3.08/5.31) | (1.32/3.49) | (3.16/8.08) | (1.32/5.05) | (3.45/10.66) |
| disclosure + Text | | | | | | |
| Perturbation | | | | | | |

Here, SI represents Speaker Identification, SD represents Speaker Diarization, which is suitable for multi-speaker complex scenes, and N represents the size of the bias list (that is, the number of preset phrases).

As illustrated in Table 1, when N=100, compared with CPPN, the method for training the audio recognition model provided by the embodiments of the present disclosure reduces the WER by 56.76% and 52.90% on the test-clean and the test-other, respectively. Similar WER, U-WER, and B-WER trends were observed for N=500 and N=1000. Under the condition of Text Perturbation, the method for training the audio recognition model provided by the embodiments of the present disclosure is superior to the best LibriSpeech scheme on the test-other with N=100. Despite failing to achieve the advantage of overall WER for other N values, the training method excels in terms of B-WER, indicating that the bias information is enhanced.

In order to demonstrate the generalization ability of shared information, experiments were conducted on Conformer. Specifically, a Conformer with a similar scale to the SEQ-former parameter was selected and divided into two groups: one group uses a share decoder at the 9-th layer while the other group does not. Both groups applied deep bias shared information at the 9-th layer. The results show that introducing the share decoder supervision into the Conformer can enhance the effect of the deep bias, thus verifying the effectiveness of the shared information.

TABLE 2

| | No shared biasing attention | | Shared biasing attention | |
|---|---|---|---|---|
| | phrase filtering | | phrase filtering | |
| N = 2000 | Test-clean | Test-other | Test-clean | Test-clean |
| SSI+TP | 2.11 | 4.76 | 1.98 | 4.46 |
| | (1.71/5.36) | (3.84/12.87) | (1.60/5.07) | (3.73/10.92) |

Table 2 illustrates the performance of the shared biasing attention phrase filtering method provided by the embodiments of the present disclosure on the LibriSpeech dataset, where the size of the bias list is that N=2000, and SSI+TP represents a combination technology of Speaker-Specific Information (SSI) and Text Post-processing (TP). Clearly, using SBA-PF significantly improves performance in terms of WER, U-WER, and B-WER. On the test-clean dataset, the relative improvements are 6.16% for WER, 6.43% for U-WER, and 5.41% for B-WER. Similar improvements are observed on the test-other dataset.

TABLE 3

| | N = 100 | |
|---|---|---|
| Model | Test-clean | Test-other |
| SEQ-former baseline | 2.29 | 4.95 |
| | (1.82/6.12) | (3.85/14.62) |
| + Shared Intermediate Encoder | 1.61 | 3.96 |
| Biasing Network | (1.21/4.88) | (3.28/9.98) |
| + Shared Intermediate Encoder Biasing | 1.47 | 3.66 |
| Network + Biasing Decoder Network | (1.11/4.35) | (3.09/8.72) |
| Sharing Attention Loss | | |
| + Shared Intermediate Encoder Biasing | 1.26 | 3.31 |
| Network + Biasing Decoder Network | (1.14/2.25) | (3.08/5.31) |
| Sharing Attention Loss + Text Perturbation | | |
| + Shared Intermediate Encoder Biasing | 1.21 | 3.26 |
| Network + Biasing Decoder Network | (1.14/1.76) | (3.08/4.87) |
| Sharing Attention Loss + Text | | |
| Perturbation + Shallow Fusion | | |

The ablation study results illustrated in Table 3 indicate that shared intermediate encoder biasing network brings the most significant performance improvement, enhancing the neural bias effect in the encoder by using shared information from intermediate layers of the SEQ-former. By introducing the Biasing Decoder Network, an additional relative performance improvement of approximately 8.70% is provided, that is, explicitly enhancing deep biasing in the decoder by sharing decoder attention loss information and employing probability rescoring. Furthermore, by combining text perturbation and shallow fusion, the performance is further improved, demonstrating that the method for training the audio recognition model provided in the embodiments of the present disclosure can effectively complement existing methods.

TABLE 4

| Method | CER (U-CER/B-CER) | RTF |
|---|---|---|
| Shared biasing attention phrase | 8.37(7.93/12.27) | 0.127 |
| filtering applied at 6-layer | | |
| Shared biasing attention phrase | 8.39(7.95/12.31) | 0.156 |
| filtering applied at 12-layer | | |
| Shared version of shared biasing | 8.37(7.93/12.27) | 0.127 |
| attention phrase filtering | | |
| Unshared version of shared | 8.57(8.02/13.46) | 0.126 |
| biasing attention phrase filtering | | |
| MLA-based shared biasing | 8.37(7.93/12.27) | 0.127 |
| attention phrase filtering | | |
| MHA-based shared biasing | 8.39(7.95/12.31) | 0.131 |
| attention phrase filtering | | |

Table 4 illustrates the strong performance of the shared biasing attention phrase filtering provided in the embodiments of the present disclosure when applied to a list containing 100,000 phrases, especially in terms of speed. Here, a CER represents the character error rate, a B-CER represents the biased character error rate (for words in the bias list), a U-CER represents the unbiased character error rate (for words not in the bias list), and a RTF represents a real-time factor, for measuring the real-time performance of the audio recognition system. The shared biasing attention phrase filtering applied at the 6-th layer outperforms its application at the 12-th layer in both speed and accuracy, indicating the effectiveness of the intermediate layer information in enhancing performance. For the unshared version of shared biasing attention phrase filtering (i.e., phrases obtained the shared biasing attention phrase filtering corresponding to different encoder layers are not shared), an independent phrase attention layer is configured for phrase filtering. The results illustrate that the shared version of shared biasing attention phrase filtering is more simpler in implementation and achieves better performance. Furthermore, MLA demonstrates higher efficiency and accuracy in phrase list filtering, providing strong capability support for processing a large-scale list input.

### 3) Model Application

Goal: applying the trained audio recognition model to actual scenarios for speech recognition.

Model deployment: deploying the trained audio recognition model to the target device, such as a server or an embedded device.

Real-time processing: processing the input speech signal in real time, extracting features and inputting the features into the audio recognition model for recognition.

Result output: outputting the recognition result as a text for subsequent applications.

Description of an exemplary structure of the apparatus 433 for training the audio recognition model according to an embodiment of the present disclosure implemented as software modules continues below. In some embodiments, as illustrated in FIG. 2, the software modules stored in the apparatus 433 for training an audio recognition model of the memory 430 may include an encoding module 4331, a decoding module 4332, and a training module 4333.

The encoding module 4331 is configured to encode an audio data sample through encoding network(s) in the audio recognition model, to obtain first encoded feature(s).

In some embodiments, the encoding module 4331 is further configured to: perform bias mapping on the first encoded feature(s) based on preset phrase(s) through a first biasing network in the audio recognition model, to obtain second encoded feature(s).

The decoding module 4332 is configured to decode the second encoded feature through a decoding network in the audio recognition model, to obtain a first text probability distribution.

In some embodiments, the decoding module 4332 is further configured to perform bias mapping on the first text probability distribution based on the preset phrase(s) through a second biasing network in the audio recognition model, to obtain a second text probability distribution.

The training module 4333 is configured to determine a loss value based on text labels for the audio data sample, the first encoded feature(s), the first text probability distribution, and the second text probability distribution.

In some embodiments, the training module 4333 is further configured to update parameters of the audio recognition model based on the loss value, to obtain a trained audio recognition model.

In some embodiments, the number of the encoding networks is multiple, the training module 4333 is further configured to: for a first encoding network among the multiple encoding networks, if the first encoding network is a head encoding network among the multiple encoding networks, determine a first loss value based on the first encoded feature output by the head encoding network and the text label; if the first encoding network is an intermediate encoding network among the multiple encoding networks, determine a second loss value based on the first encoded feature output by the intermediate encoding network, the first text probability distribution, and the text label; if the first encoding network is a tail encoding network among the multiple encoding networks, determine a third loss value based on the first encoded feature output by the tail encoding network and the text label; determine an encoding-side loss value based on the first loss value, the second loss value, and the third loss value, and determine a decoding-side loss value based on the first text probability distribution, the second text probability distribution, and the text label; and fuse the encoding-side loss value and the decoding-side loss value, to obtain the loss value.

In some embodiments, the training module 4333 is further configured to: determine a first sub-loss value based on the first encoded feature output by the head encoding network and phrase labels, where the phrase labels include phrase(s) in the text labels matching the preset phrase(s); determine a second sub-loss value based on the first encoded feature output by the head encoding network and the text label; and fuse the first sub-loss value and the second sub-loss value, to obtain the first loss value.

In some embodiments, the training module 4333 is further configured to: determine a third sub-loss value based on the first encoded feature output by the intermediate encoding network and phrase labels, where the phrase labels include phrase(s) in the text labels matching the preset phrase(s); fuse the first encoded feature output by the intermediate encoding network and the first text probability distribution to obtain a third encoded feature, and determine a fourth sub-loss value based on the third encoded feature and the text label; decode the first encoded feature output by the intermediate encoding network through the decoding network in the audio recognition model, to obtain a third text probability distribution, and determine a fifth sub-loss value based on the third text probability distribution and the text label; and fuse the third sub-loss value, the fourth sub-loss value, and the fifth sub-loss value, to obtain the second loss value.

In some embodiments, the number of the encoding networks is multiple, the encoding module 4331 is further configured to: for a first encoding network among the multiple encoding networks, if the first encoding network is a head encoding network among the multiple encoding networks, perform attention processing on the preset phrase(s) and the first encoded feature to obtain a first attention feature, and fuse the first encoded feature and the first attention feature to obtain the second encoded feature; if the first encoding network is any encoding network after the head encoding network, filter from the preset phrases to obtain first phrase(s), perform attention processing on the first phrase(s) and the first encoded feature to obtain a second attention feature, and fuse the first encoded feature and the second attention feature to obtain the second encoded feature.

In some embodiments, the preset phrases include multiple phrases, the first attention feature includes attention features corresponding to respective audio frames in the audio data sample, and the number of the encoding networks is multiple. The encoding module 4331 is further configured to: determine, for an attention feature corresponding to each of the audio frames, an attention score matrix corresponding to the attention feature, where the attention score matrix includes attention scores for the multiple phrases; determine a preset number of phrases from the multiple phrases based on a descending order of the attention scores, and determine the preset number of phrases as multiple second phrases corresponding to the respective audio frame; and construct a set of second phrases corresponding to the respective audio frames, count a number of occurrences of each of the second phrases in the set, and determine second phrase(s) with the number of occurrences greater than a preset threshold as the first phrase(s).

In some embodiments, the training module 4333 is further configured to: perform audio recognition on audio data to be recognized based on the trained audio recognition model, to obtain a first text corresponding to the audio data to be recognized.

In some embodiments, the training module 4333 is further configured to: encode the audio data to be recognized through the encoding network(s) in the trained audio recognition model, to obtain third encoded feature(s); perform bias mapping on the third encoded feature(s) based on the preset phrase(s) through the first biasing network in the trained audio recognition model, to obtain fourth encoded feature(s); decode the fourth encoded feature through the decoding network in the trained audio recognition model, to obtain a fourth text probability distribution; perform bias mapping on the fourth text probability distribution based on the preset phrase(s) through the second biasing network in the trained audio recognition model, to obtain a fifth text probability distribution; generate multiple second texts based on the fifth text probability distribution; and filter from the multiple second texts based on first evaluation scores of the multiple second texts, to obtain the first text.

In some embodiments, the training module 4333 is further configured to: for each of the multiple second texts, score, based on the second text and the fourth encoded feature, an alignment degree between the second text and the audio data to be recognized, to determine a second evaluation score; for each of the multiple second texts, score, based on the second text and the fourth encoded feature, semantic coherence of the second text, to determine a third evaluation score; for each of the multiple second texts, score, based on the second text and the preset phrase(s), correlation between the second text and the preset phrase(s), to determine a fourth evaluation score; and fuse the second evaluation score, the third evaluation score, and the fourth evaluation score, to determine the first evaluation score.

An embodiment of the present disclosure provides a computer program product, including a computer program or a computer-executable instruction stored in a computer-readable storage medium. A processor of an electronic device reads the computer-executable instruction from the computer-readable storage medium, and the processor executes the computer-executable instruction to cause the electronic device to perform the method for training the audio recognition model described above in the embodiments of the present disclosure.

An embodiment of the present disclosure provides a computer-readable storage medium, storing a computer-executable instruction or a computer program that, when executed by a processor, causes the processor to perform the method for training the audio recognition model according to the embodiments of the present disclosure, for example, the method for training the audio recognition model illustrated in FIG. 3A.

In some embodiments, the computer-readable storage medium may be a memory such as a RAM, a ROM, a flash memory, a magnetic surface memory, an optical disc, or a CD-ROM, or may be various devices including one or any combination of the above memories.

In some embodiments, the computer-executable instruction may be in the form of a program, software, software module, script or code, and written in any form of programming language (including a compiled or interpreted language, or a declarative or procedural language), and may be deployed in any form, including as a stand-alone program or as a module, component, subroutine, or another unit suitable for use in a computing environment.

For example, the computer-executable instruction may, but does not necessarily, correspond to a file in a file system, and may be stored in a part of a file storing other programs or data, for example, in one or more scripts in a Hyper Text Markup Language (HTML) document, in a single file dedicated to the program in question, or in multiple coordinated files (for example, files storing one or more modules, sub-programs, or code portions).

For example, the computer-executable instruction may be deployed to be executed on one electronic device, or on multiple electronic devices located at one site, or on multiple electronic devices distributed at multiple sites and interconnected by a communication network.

In summary, according to the embodiments of the present disclosure, by introducing a first biasing network into the audio recognition model, bias mapping is performed on the first coding feature obtained through encoding processing based on preset phrase(s), the audio recognition model is guided to pay attention to specific vocabularies (i.e. the preset phrases). By introducing a second biasing network, bias mapping is performed on the first text probability distribution obtained after performing decoding processing, the recognition for the preset phrase(s) is further optimized. By a design of a loss value that combines supervision signals from the first encoded feature, the first text probability distribution, the second text probability distribution and the text label, the audio recognition model achieves enhanced semantic focus capability and robustness, thereby improving the audio recognition accuracy.

The foregoing contents are merely embodiments of the present disclosure, and are not intended to limit the scope of protection of the present disclosure. Any modifications, equivalent substitutions, improvements, and the like made within the spirit and scope of the present disclosure are encompassed within the scope of protection of the present disclosure.

1. A method for training a model, comprising:
encoding an audio data sample using an encoder in the model, to obtain first feature vectors;
performing attention mapping on the first feature vectors based on at least one preset phrase using a biasing encoder in the model, to obtain second feature vectors;
decoding the second feature vectors using a decoder in the model, to obtain first probabilities;
performing attention mapping on the first probabilities based on the at least one preset phrase using a biasing decoder in the model, to obtain second probabilities;
determining a loss value based on text labels for the audio data sample, the first feature vectors, the first probabilities, and the second probabilities; and
tuning parameters of the model based on the loss value, to obtain a trained model.

2. The method of claim 1, wherein
the encoder comprises a plurality of encoding networks; and the determining a loss value based on text labels for the audio data sample, the first feature vectors, the first probabilities, and the second probabilities comprises:
for a first encoding network among the plurality of encoding networks, in response to the first encoding network being a head encoding network among the plurality of encoding networks, determining a first loss value based on the first feature vectors output by the head encoding network and the text labels;
in response to the first encoding network being an intermediate encoding network among the plurality of encoding networks, determining a second loss value based on the first feature vectors output by the intermediate encoding network, the first probabilities, and the text labels;
in response to the first encoding network being a tail encoding network among the plurality of encoding networks, determining a third loss value based on the first feature vectors output by the tail encoding network and the text labels;
determining an encoding-side loss value based on the first loss value, the second loss value, and the third loss value, and determining a decoding-side loss value based on the first probabilities, the second probabilities, and the text labels; and
fusing the encoding-side loss value and the decoding-side loss value, to obtain the loss value.

3. The method of claim 2, wherein
the determining a first loss value based on the first feature vectors output by the head encoding network and the text labels comprises:
determining a first sub-loss value based on the first feature vectors output by the head encoding network and phrase labels, wherein the phrase labels comprise at least one phrase in the text labels matching the at least one preset phrase;
determining a second sub-loss value based on the first feature vectors output by the head encoding network and the text labels; and
fusing the first sub-loss value and the second sub-loss value, to obtain the first loss value.

4. The method of claim 2, wherein
the determining a second loss value based on the first feature vectors output by the intermediate encoding network, the first probabilities, and the text labels comprises:
determining a third sub-loss value based on the first feature vectors output by the intermediate encoding network and phrase labels, wherein the phrase labels comprise at least one phrase in the text labels matching the at least one preset phrase;
fusing the first feature vectors output by the intermediate encoding network and the first probabilities to obtain third feature vectors, and determining a fourth sub-loss value based on the third feature vectors and the text labels;
decoding the first feature vectors output by the intermediate encoding network using the decoder in the model, to obtain third probabilities, and determining a fifth sub-loss value based on the third probabilities and the text labels; and
fusing the third sub-loss value, the fourth sub-loss value, and the fifth sub-loss value, to obtain the second loss value.

5. The method of claim 1, wherein
the encoder comprises a plurality of encoding networks; and the performing attention mapping on the first feature vectors based on at least one preset phrase using a biasing encoder in the model, to obtain second feature vectors comprises:
for a first encoding network among the plurality of encoding networks, in response to the first encoding network being a head encoding network among the plurality of encoding networks, performing attention processing on the at least one preset phrase and the first feature vectors to obtain first attention feature vectors, and fusing the first feature vectors and the first attention feature vectors to obtain the second feature vectors; and
in response to the first encoding network being any encoding network after the head encoding network, filtering from the at least one preset phrase to obtain at least one first phrase, performing attention processing on the at least one first phrase and the first feature vectors to obtain second attention feature vectors, and fusing the first feature vectors and the second attention feature vectors to obtain the second feature vectors.

6. The method of claim 5, wherein
the at least one preset phrase comprises a plurality of phrases; the first attention feature vectors comprise attention feature vectors corresponding to a plurality of audio frames in the audio data sample; and the filtering from the at least one preset phrase to obtain at least one first phrase comprises:
for an attention feature vector corresponding to each of the audio frames, determining an attention score matrix corresponding to the attention feature vector, wherein the attention score matrix comprises attention scores for the plurality of phrases;
determining a preset number of phrases from the plurality of phrases based on a descending order of the attention scores, and determining the preset number of phrases as a plurality of second phrases corresponding to the each audio frame; and
constructing a set of second phrases corresponding to the plurality of audio frames, counting a number of occurrences of each of the second phrases in the set, and determining at least one second phrase with the number of occurrences greater than a preset threshold as the at least one first phrase.

7. The method of claim 1, further comprising: after obtaining the trained model,
performing audio recognition on audio data to be recognized based on the trained model, to obtain a first text corresponding to the audio data to be recognized.

8. The method of claim 7, wherein the performing audio recognition on audio data to be recognized based on the trained model, to obtain a first text corresponding to the audio data to be recognized comprises:
encoding the audio data to be recognized using the encoder in the trained model, to obtain third feature vectors;
performing attention mapping on the third feature vectors based on the at least one preset phrase using the biasing encoder in the trained model, to obtain fourth feature vectors;
decoding the fourth feature vectors using the decoder in the trained model, to obtain fourth probabilities;
performing attention mapping on the fourth probabilities based on the at least one preset phrase using the biasing decoder in the trained model, to obtain fifth probabilities;
generating a plurality of second texts based on the fifth probabilities; and
filtering from the plurality of second texts based on first evaluation scores of the plurality of second texts, to obtain the first text.

9. The method of claim 8, further comprising: before filtering from the plurality of second texts based on the first evaluation scores of the plurality of second texts to obtain the first text,
for each of the plurality of second texts,
scoring, based on the second text and the fourth feature vectors, an alignment degree between the second text and the audio data to be recognized, to determine a second evaluation score;
scoring, based on the second text and the fourth feature vectors, semantic coherence of the second text, to determine a third evaluation score;
scoring, based on the second text and the at least one preset phrase, correlation between the second text and the at least one preset phrase, to determine a fourth evaluation score; and
fusing the second evaluation score, the third evaluation score, and the fourth evaluation score, to determine the first evaluation score.

10. An electronic device, comprising:
a memory, configured to store computer-executable instructions or a computer program; and
a processor, configured to execute the computer-executable instructions or the computer program stored in the memory to implement operations of:
encoding an audio data sample using an encoder in a model, to obtain first feature vectors;
performing attention mapping on the first feature vectors based on at least one preset phrase using a biasing encoder in the model, to obtain second feature vectors;
decoding the second feature vectors using a decoder in the model, to obtain first probabilities;
performing attention mapping on the first probabilities based on the at least one preset phrase using a biasing decoder in the model, to obtain second probabilities;
determining a loss value based on text labels for the audio data sample, the first feature vectors, the first probabilities, and the second probabilities; and
tuning parameters of the model based on the loss value, to obtain a trained model.

11. The electronic device of claim 10, wherein
the encoder comprises a plurality of encoding networks; and the processor is further configured to execute the computer-executable instructions or the computer program to:
for a first encoding network among the plurality of encoding networks, in response to the first encoding network being a head encoding network among the plurality of encoding networks, determine a first loss value based on the first feature vectors output by the head encoding network and the text labels;
in response to the first encoding network being an intermediate encoding network among the plurality of encoding networks, determine a second loss value based on the first feature vectors output by the intermediate encoding network, the first probabilities, and the text labels;
in response to the first encoding network being a tail encoding network among the plurality of encoding networks, determine a third loss value based on the first feature vectors output by the tail encoding network and the text labels;
determine an encoding-side loss value based on the first loss value, the second loss value, and the third loss value, and determine a decoding-side loss value based on the first probabilities, the second probabilities, and the text labels; and
fuse the encoding-side loss value and the decoding-side loss value, to obtain the loss value.

12. The electronic device of claim 11, wherein
the processor is further configured to execute the computer-executable instructions or the computer program to:
determine a first sub-loss value based on the first feature vectors output by the head encoding network and phrase labels, wherein the phrase labels comprise at least one phrase in the text labels matching the at least one preset phrase;
determine a second sub-loss value based on the first feature vectors output by the head encoding network and the text labels; and
fuse the first sub-loss value and the second sub-loss value, to obtain the first loss value.

13. The electronic device of claim 11, wherein
the processor is further configured to execute the computer-executable instructions or the computer program to:
determine a third sub-loss value based on the first feature vectors output by the intermediate encoding network and phrase labels, wherein the phrase labels comprise at least one phrase in the text labels matching the at least one preset phrase;
fuse the first feature vectors output by the intermediate encoding network and the first probabilities to obtain third feature vectors, and determine a fourth sub-loss value based on the third feature vectors and the text labels;
decode the first feature vectors output by the intermediate encoding network using the decoder in the model, to obtain third probabilities, and determine a fifth sub-loss value based on the third probabilities and the text labels; and
fuse the third sub-loss value, the fourth sub-loss value, and the fifth sub-loss value, to obtain the second loss value.

14. The electronic device of claim 10, wherein
the encoder comprises a plurality of encoding networks; and the processor is further configured to execute the computer-executable instructions or the computer program to:
for a first encoding network among the plurality of encoding networks, in response to the first encoding network being a head encoding network among the plurality of encoding networks, perform attention processing on the at least one preset phrase and the first feature vectors to obtain first attention feature vectors, and fuse the first feature vectors and the first attention feature vectors to obtain the second feature vectors; and
in response to the first encoding network being any encoding network after the head encoding network, filter from the at least one preset phrase to obtain at least one first phrase, perform attention processing on the at least one first phrase and the first feature vectors to obtain second attention feature vectors, and fuse the first feature vectors and the second attention feature vectors to obtain the second feature vectors.

15. The electronic device of claim 14, wherein
the at least one preset phrase comprises a plurality of phrases; the first attention feature vectors comprise attention feature vectors corresponding to a plurality of audio frames in the audio data sample; and the processor is further configured to execute the computer-executable instructions or the computer program to:
for an attention feature vector corresponding to each of the audio frames, determine an attention score matrix corresponding to the attention feature vector, wherein the attention score matrix comprises attention scores for the plurality of phrases;
determine a preset number of phrases from the plurality of phrases based on a descending order of the attention scores, and determine the preset number of phrases as a plurality of second phrases corresponding to the each audio frame; and
construct a set of second phrases corresponding to the plurality of audio frames, count a number of occurrences of each of the second phrases in the set, and determine at least one second phrase with the number of occurrences greater than a preset threshold as the at least one first phrase.

16. The electronic device of claim 10, wherein the processor is further configured to execute the computer-executable instructions or the computer program to:
perform audio recognition on audio data to be recognized based on the trained model, to obtain a first text corresponding to the audio data to be recognized.

17. The electronic device of claim 16, wherein the processor is further configured to execute the computer-executable instructions or the computer program to:
encode the audio data to be recognized using the encoder in the trained model, to obtain third feature vectors;
perform attention mapping on the third feature vectors based on the at least one preset phrase using the biasing encoder in the trained model, to obtain fourth feature vectors;
decode the fourth feature vectors using the decoder in the trained model, to obtain fourth probabilities;
perform attention mapping on the fourth probabilities based on the at least one preset phrase using the biasing decoder in the trained model, to obtain fifth probabilities;
generate a plurality of second texts based on the fifth probabilities; and
filter from the plurality of second texts based on first evaluation scores of the plurality of second texts, to obtain the first text.

18. The electronic device of claim 17, wherein the processor is further configured to execute the computer-executable instructions or the computer program to:
for each of the plurality of second texts,
score, based on the second text and the fourth feature vectors, an alignment degree between the second text and the audio data to be recognized, to determine a second evaluation score;
score, based on the second text and the fourth feature vectors, semantic coherence of the second text, to determine a third evaluation score;
score, based on the second text and the at least one preset phrase, correlation between the second text and the at least one preset phrase, to determine a fourth evaluation score; and
fuse the second evaluation score, the third evaluation score, and the fourth evaluation score, to determine the first evaluation score.

19. A non-transitory computer-readable storage medium having stored thereon computer-executable instructions or a computer program that, when executed by a processor, implement or implements a method for training a model including:
encoding an audio data sample using an encoder in the model, to obtain first feature vectors;
performing attention mapping on the first feature vectors based on at least one preset phrase using a biasing encoder in the model, to obtain second feature vectors;
decoding the second feature vectors using a decoder in the model, to obtain first probabilities;
performing attention mapping on the first probabilities based on the at least one preset phrase using a biasing decoder in the model, to obtain second probabilities;
determining a loss value based on text labels for the audio data sample, the first feature vectors, the first probabilities, and the second probabilities; and
tuning parameters of the model based on the loss value, to obtain a trained model.

20. The non-transitory computer-readable storage medium of claim 19, wherein the encoder comprises a plurality of encoding networks; and the determining a loss value based on text labels for the audio data sample, the first feature vectors, the first probabilities, and the second probabilities comprises:
for a first encoding network among the plurality of encoding networks, in response to the first encoding network being a head encoding network among the plurality of encoding networks, determining a first loss value based on the first feature vectors output by the head encoding network and the text labels;
in response to the first encoding network being an intermediate encoding network among the plurality of encoding networks, determining a second loss value based on the first feature vectors output by the intermediate encoding network, the first probabilities, and the text labels;
in response to the first encoding network being a tail encoding network among the plurality of encoding networks, determining a third loss value based on the first feature vectors output by the tail encoding network and the text labels;
determining an encoding-side loss value based on the first loss value, the second loss value, and the third loss value, and determining a decoding-side loss value based on the first probabilities, the second probabilities, and the text labels; and
fusing the encoding-side loss value and the decoding-side loss value, to obtain the loss value.
